(19) United States
(12) Patent Application Publication
(10) Pub. No.: US 2025/0181668 A1
(43) Pub. Date: Jun. 5, 2025

(54) SYSTEMS AND METHODS FOR COMPUTING SHAPLEY ADDITIVE VALUES USING MODEL STRUCTURE INFORMATION

(71) Applicant: Wells Fargo Bank, N.A., San Francisco, CA (US)

(72) Inventors: Linwei Hu, Charlotte, NC (US); Ke Wang, Charlotte, NC (US)

(21) Appl. No.: 18/525,331

(22) Filed: Nov. 30, 2023

(51) Int. Cl. G06F 17/12

(52) U.S. Cl. CPC G06F 17/12

(57) ABSTRACT

Systems, apparatuses, methods, and computer program products are disclosed for computing a Shapley additive explanation (SHAP) value ϕᵢ using model structure information. An example method includes receiving a model ƒ(x) that uses a vector of features x as input, where the model has a known functional decomposition and generating, using the known functional decomposition, a set of lower order terms ƒᵥ(xᵥ), where a lower order term from the set of lower order terms takes a subset of the features as input, where a sum of the set of lower order terms equals the model ƒ(x). The example method further includes computing a set of lower-order SHAP values ϕᵢ(ƒᵥ) for the set of lower order terms and computing the SHAP value ϕᵢ for the model based on a sum of the set of lower-order SHAP values.

### BACKGROUND

Explaining a model's output is extremely important in many fields. In consumer lending, banks are required to provide reasons for declined credit application. In healthcare, interpretation of predictions can help researchers better understand diseases. Local interpretation methods may be able to provide explanations for individual predictions.

### BRIEF SUMMARY

SHAP (SHapley Additive exPlanations) is a local interpretation approach to attribute the prediction of a machine-learning model on an input to its features. The SHAP explanation method computes Shapley values, a concept from coalitional game theory. The feature values of a data instance act as players in a coalition. Shapley values provide a way to fairly distribute the payout (e.g., the prediction) among the features. The Shapley value is the only attribution method that satisfies the desirable properties efficiency, symmetry, dummy, and additivity, which together are considered a definition of a fair payout. There are different variations of SHAP for different models and applications, examples include kernel SHAP and Baseline-SHAP (B-SHAP).

Despite the benefits, computing Shapley values is extremely computationally expensive because it requires the order of 2^{p} function evaluations, p being the number of features in the model. There are multiple ways aiming at speeding up computing Shapley values. One strategy is that instead of computing Shapley values exactly, approximated Shapley values can be computed using sampling methods. However, as shown below, existing methods for generating these estimates can produce results that are far from the true values.

To avoid the errors in sampling methods, new solutions are needed to compute Shapley values precisely. Example embodiments disclosed herein implement strategies of computing Shapley values exactly for a class of SHAP definitions that satisfy additivity and dummy assumptions (described below), by taking advantage of the model structure information. First, it is shown herein that Shapley values can be computed much more efficiently if the models have known structure, e.g., ƒ(x)=Σ_{v⊆{1, 2, . . . , p}}ƒᵥ(xᵥ) and all the components are low dimensional (|v| is small). In particular, main-effect plus two-way interaction models, ƒ(x)=Σᵢƒᵢ(xᵢ)+Σ_{i,j}ƒᵢⱼ(xᵢ,xⱼ), have become popular recently due to the good model performance and interpretability. For a black-box model, some example embodiments may obtain these structures by using Functional ANOVA (fANOVA) decomposition, which is one way to express complex models as the sum of components with low orders. Since the Shapley values of each functional component can be computed efficiently, by using the additive property of computing Shapley values introduced in this work later, the Shapley values of the complicated model can then be computed by adding the Shapley values of each low-order component.

Second, when a functional decomposition of a model is not available but the order of the model is known, example embodiments disclosed herein use formulas that can compute Shapley values efficiently in polynomial time. Here, the order of a model is defined as the maximum order of interactions in the model. For example, an xgboost model with max_depth=4 has an order of 4, because it has at most 4-way interactions.

Finally, when the order of the model is unknown, it has been observed that the true underlying model is usually either low-order or approximately low-order, or in other words, the high-order interactions are weak. Based on this fact, example embodiments disclosed herein use an iterative way to approximate the Shapley values with low-order results. Examples described herein may start from computing Shapley values assuming order K=1, then keep increasing the order until the Shapley values converge. Some of the example embodiments disclosed herein:

a. Demonstrate an additive property when computing SHAP for SHAP definitions that satisfy our additivity and dummy assumptions, including B-SHAP and kernel SHAP. With this property, SHAP can be computed very efficiently with knowledge of the functional decomposition of the model and when the components are low order.

b. Derive formulas of computing SHAP exactly for models with unknown functional decomposition but known model order. Using these formulas, SHAP values can be computed efficiently in polynomial time.

c. Disclose an iterative way to approximate SHAP with low-order formulas in (b) when the model order is unknown.

In addition to the above example embodiments, the following description shows the advantage of example embodiments compared to sampling approach through simulations.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIGS. 1A, 1B, 1C, and 1D illustrate computing B-SHAP for an order-2 model using the sampling method in Captum, the open source model interpretability library. The sampled B-SHAP \hat{ϕ}ᵢ are compared with true ϕᵢ.

FIGS. 2A, 2B, 2C, and 2D illustrate computing B-SHAP for an order-4 model using the sampling method in Captum.

FIG. 3 illustrates the relative difference between SHAP values with different orders and the true SHAP values. The titles show the coefficients.

FIGS. 4A, 4B, 4C, and 4D illustrate computing B-SHAP for an order-6 model with coefficient 0.5 using the sampling method in Captum. The sampled B-SHAP j are compared with true ϕᵢ.

FIGS. 5A, 5B, 5C, and 5D illustrate computing B-SHAP for an order-6 model with coefficient 1 using the sampling method in Captum. The sampled B-SHAP j are compared with true ϕᵢ.

FIGS. 6A, 6B, 6C, and 6D illustrate computing B-SHAP for an order-6 model with coefficient 2 using the sampling method in Captum. The sampled B-SHAP j are compared with true ϕᵢ.

FIG. 7 illustrates a system in which some example embodiments may be used for computing SHAP values using model structure information.

FIG. 8 illustrates a schematic block diagram of example circuitry embodying a system device that may perform various operations in accordance with some example embodiments described herein.

FIG. 9 illustrates an example flowchart for computing SHAP values using model structure information with a known functional decomposition, in accordance with some example embodiments described herein.

FIG. 10 illustrates an example flowchart for computing SHAP values using model structure information of a model based on the model order, in accordance with some example embodiments described herein.

FIG. 11 illustrates another example flowchart for determining a model order K for the model explanation, in accordance with some example embodiments described herein.

FIG. 12 illustrates another example flowchart for determining a model order K for the model explanation, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### Methodologies

### Shapley Values

We let function ƒ(x) be a fitted machine-learning model that takes a p-dimensional vector x as input. The Shapley value computes attributions ϕᵢ for each feature i. The Shapley value of feature i is given by:

$${ϕ}_{i} = {\sum }_{u ⊆ M ∖ i} \frac{\vert u \vert ! ( p - \vert u \vert - 1 ) !}{p !} ( c ( f , u + i ) - c ( f , u ) ) , \qquad ( 1 )$$

where M is the set of all p features {1, 2, . . . , p}, c(ƒ,u) is the cost function of model ƒ evaluating at set u. More details regarding the cost function are introduced in connection with example embodiments described below. The term c(ƒ,u+i)−c(ƒ,u) can be viewed as the contribution of feature/player i given set/players u, and is called “gradient”. An intuitive way to explain Shapley value is to compute the gradient (c(ƒ,u+i)−c(ƒ,u)) with all subsets of u and then take the weighted average.

An alternative way to express Shapley value is based on permutations,

$${ϕ}_{i} = {\sum }_{S ⊆ Perm ( p )} \frac{1}{p !} ( c ( f , {Pre}^{i} ( S ) + i ) - c ( f , Pr {e}^{i} ( S ) ) ) , \qquad ( 2 )$$

where Perm(p) includes all permutations of numbers {1, . . . , p}, and S is one single permutation, e.g., S={3, 5, 1, . . . }. Preⁱ(S) is the set of predecessors of i in S. When i=1 and S={3, 5, 1, . . . }, Pre¹(S)={3, 5}. In this expression, ϕᵢ can be viewed as the average of the gradient (c(ƒ,Preⁱ(S)+i)−c(ƒ,Preⁱ(S)). This expression is used in computing Shapley values approximately, including methods that sample m permutations among all p! permutations, then compute the gradients for these sampled permutations and take the average. This estimate is unbiased because EQ. 2 is the average over all permutations.

Shapley values satisfy some desirable properties: efficiency, symmetry, dummy and additivity. These properties guarantee a fair payout and are important to satisfy when computing Shapley values for different applications.

There are different Shapley value definitions based on different cost functions, and two example are given below. The first variant is kernel SHAP, which defines

$$c ( f , u ) = \int f ( x ) dP ( {x}_{\overline{u}} ) , \overline{u} = \{ 1 , … , p \} ∖ u .$$

c(ƒ,u) in kernel SHAP can be viewed as computing the average of model function value ƒ(x) over the distribution of x_{ū}.

The second variant is Baseline SHAP (B-SHAP). In B-SHAP, there is a baseline/reference point z. The goal now is to explain the difference ƒ(x)−ƒ(z) by computing the contribution of each feature. Given the baseline point z, the cost function in B-SHAP is defined as

c(ƒ,u)=ƒ(xᵤ,z_{ū}).

B-SHAP is a useful tool in credit lending. When a financial institution declines an application for credit, B-SHAP can be used to help explain the reason of the decision.

There are other SHAP definitions using different cost functions. In example embodiments disclosed herein, we assume that the cost function satisfies two properties.

Assumption 1. a. Additivity: c(ƒ₁+ƒ₂,u)=c(ƒ₁,u)+c(ƒ₂,u). b. Dummy: If ƒ(x)=ƒᵥ(xᵥ) only depends on xᵥ, c(ƒᵥ,u)=c(ƒᵥ,u∩v).

Additivity implies that the cost of the sum is the sum of the cost values. Dummy implies that the features that are not included in the model function will not affect the cost function. Both kernel SHAP and B-SHAP satisfy Assumption 1. However, the dummy assumption does not hold for conditional SHAP with cost function c(ƒ,u)=∫ƒ(x)dP(x_{ū}|xᵤ).

Computing SHAP with Known Functional Decomposition

SHAP can be computed efficiently and exactly with a known functional decomposition. Many machine learning models act as a “black box”: taking a high-dimensional vector as an input and predicting an output. Functional decomposition is an interpretation technique that decomposes the high-dimensional function and expresses it as the sum of individual feature effects and interaction effects with relatively low-dimensions. Any function can be decomposed in numerous ways. One way is called functional ANOVA (fANOVA) decomposition, which imposes hierarchical orthogonality constraints among its components to guarantee a unique decomposition, ∫ƒᵤ(xᵤ)ƒᵥ(xᵥ)w(x)dx=0, ∀u⊂v and w(x) is the joint distribution of predictors. Proposition 1 below applies to any decomposition (not only fANOVA decomposition). Similarly, example embodiments disclosed herein may use fANOVA or may use any decomposition. Example embodiments may compute SHAP efficiently by using the additive property of SHAP.

Proposition 1. Assume that the model can be decomposed into lower order terms as ƒ(x)=Σ_{v⊆M}ƒᵥ(xᵥ) and Assumption 1 holds, then ϕᵢ=Σ_{i∈v}ϕᵢ(ƒᵥ), where ϕᵢ(ƒᵥ) is the SHAP value of feature i for function component ƒᵥ.

Intuitively, the additivity in Proposition 1 means that the SHAP value for the high-dimensional function ƒ(x) is simply the sum of SHAP value for all its low dimensional components which contain the variable xᵢ. For illustration, consider the following two simple examples.

Example 1. For an additive model ƒ(x)=Σⱼƒⱼ(xⱼ), Proposition 1 means ϕᵢ=ϕᵢ(ƒᵢ), which is ƒᵢ(xᵢ)−ƒᵢ(zᵢ) in the B-SHAP case and ƒᵢ(xᵢ)−∫ƒᵢ(xᵢ)dxᵢ in the kernel SHAP case.

Example 2. For an additive model with one two-way interaction, (e.g., ƒ(x)=Σⱼƒⱼ(xⱼ)+ƒ₁₂(x₁x₂)), Proposition 1 states that ϕ₁=ϕ₁(ƒ₁)+ϕ₁(ƒ₁₂), ϕ₂=ϕ₂(ƒ₂)+ϕ₂(ƒ₁₂) and ϕᵢ=ϕᵢ(ƒᵢ) for i=3, 4, . . . , p. Applying Equation (1) to the case of B-shap, ϕ₁(ƒ₁₂)=1/2[ƒ₁₂(xᵢ,z₂)−ƒ₁₂(z₁,z₂)]+1/2[ƒ₁₂(x₁,x₂)−ƒ₁₂(z₁,x₂)]. The computation is done similarly for ϕ₂(ƒ₁₂).

Computing ϕᵢ(ƒᵥ) using Equation (1) is feasible when |v| is small. It only involves evaluating the cost function c(ƒᵥ,u) on 2^{|v|} subsets (e.g, 2⁵=32). The total cost of computing ϕᵢ, Σ_{i∈v}O(2^{|v|}), does not grow exponentially with p; it is upper bounded by the order of model and number of function components. When the order of model is not high and the interactions are sparse, computing SHAP values in this way can be very efficient.

Corollary 1. If the variables are independent and ƒ(x)=Σ_{v⊆M}ƒᵥ(xᵥ) is the fANOVA decomposition which satisfies the orthogonality constraint, then for kernel SHAP, we have

$${ϕ}_{i} = {\sum }_{i ∈ v} \frac{1}{\vert v \vert} {f}_{v} ( {x}_{v} ) .$$

Corollary 1 gives an explicit and simple expression for kernel SHAP under independence assumption. It attributes the prediction of each component ƒᵥ(xᵥ) evenly among the lvi variables. For example, consider the model ƒ(x)=Σⱼxⱼ+x₁x₂ where xᵢ˜iid Normal (0,1). The decomposition already satisfies the orthogonality constraint because E(x₁x₂×x₁)=0 and E(x₁x₂×x₂)=0. So Corollary 1 implies that the kernel SHAP ϕ₁=x₁+1/2 x₁x₂ and ϕ₂=x₂+1/2 x₁x₂. However, when the variables are not independent, there is no such simple solution.

Computing SHAP with Model of Known Order

In the case that we do not have the functional decomposition of the model, example embodiments may still compute SHAP efficiently in polynomial time if the order of the model is known. Theorem 1 below does not require to know the decomposition; it relies only on the overall model prediction ƒ(x) and the order of model.

Theorem 1. Assume the model ƒ(x) has order K and Assumption 1 holds, then,

(1) When the model is additive, i.e., K=1, we have for any subset u⊆M\i,

$${ϕ}_{i} = c ( f , u + i ) - c ( f , u ) .$$

(2) When the model has up to 2-way interactions, i.e., K=2, we have for any subset u⊆M\i,

$${ϕ}_{i} = \frac{1}{2} ( c ( f , u + i ) − c ( f , u ) + c ( f , \overline{u} ) − c ( f , \overline{u + l} ) ) , \overline{u} = M ∖ u .$$

In other words, ϕᵢ is the average of gradients w.r.t. (any) set u and its complement set u̅+̅i̅.

(3) When K≥3, let q=└(K−1)/2┘, where └ ┘ is the floor function. Then,

$${ϕ}_{i} = {\sum }_{m = 0}^{q} {a}_{m} ( {d}_{m} + {d}_{p - m - 1} ) ,$$

where

$${d}_{m} = \frac{1}{( \begin{matrix}p - 1 \\ m\end{matrix} )} {\sum }_{u : \vert u \vert = m , u ⊆ M ∖ i} ( c ( f , u + i ) - c ( f , u ) )$$

is the average gradient for all subsets with cardinality m, and the coefficients aₘ can be obtained by solving the q+1 equations

$$2 {\sum }_{m = r}^{q} {a}_{m} \frac{( \begin{matrix}p - 2 r - 1 \\ m - r\end{matrix} )}{( \begin{matrix}p - 1 \\ m\end{matrix} )} = \frac{r ! r !}{( 2 r + 1 ) !} , r = 0 , … , q \qquad ( 3 )$$

Here we provide a brief explanation focusing on B-shap. In Example 1, we know ϕᵢ=ƒᵢ(xᵢ)−ƒᵢ(zᵢ) from the previous description. On the other hand, for any subset u⊆M\i, c(ƒ,u+i)−c(ƒ,u)=[|Σ_{j∈u+i}ƒⱼ(xⱼ)+Σ_{j∉u+i}ƒⱼ(zⱼ)]−[Σ_{j∈u}ƒⱼ(xⱼ)+Σ_{j∉u}ƒⱼ(zⱼ)]=ƒᵢ(xᵢ)−ƒᵢ(zᵢ). So the conclusion holds and we only need to evaluate the cost function twice. In Example 2, ϕ₁=ƒ₁(x₁)−ƒ₁(z₁)+1/2[ƒ₁₂(x₁,z₂)−ƒ₁₂(z₁,z₂)]+1/2[ƒ₁₂(x₁,x₂)−ƒ₁₂(zᵢ,x₂)] from the previous description. On the other hand,

$$c ( f , u + 1 ) - c ( f , u ) = {f}_{1} ( {x}_{1} ) - {f}_{1} ( {z}_{1} ) + \{ \begin{matrix}{f}_{12} ( {x}_{1} , {x}_{2} ) - {f}_{12} ( {z}_{1} , {x}_{2} ) , if 2 ∈ u \\ {f}_{12} ( {x}_{1} , {z}_{2} ) - {f}_{12} ( {z}_{1} , {z}_{2} ) , if 2 ∉ u\end{matrix}$$

The gradient depends only on if 2∈u or not, and the true ϕ₁ is an average of the two scenarios. So a natural choice is to select any subset u and its complement u̅+̅i̅ and take average on the two gradients. This approach works for any order-2 models. The computation cost is only 4 cost function evaluations.

When the model is of order K≥3, given K is relatively small compared to p, it may suggest us to only look at cost functions for subsets with small cardinalities. However, as seen from the order-2 case, we also need the complement subsets to “balance out” to get an unbiased estimate. Therefore, we will also include the subsets with high cardinalities. The final step is to find the appropriate coefficients aₘ's. This is done by solving EQ. 3. Note EQ. 3 forms a triangular system of linear equations which can be solved easily and the solution uniquely exists.

Using the formula in Theorem 1 can improve the speed of computing SHAP significantly, especially when the model order is not high, because only the subsets on two “tails” will be evaluated. Imagine the case that the model order is 3 or 4, then q=1. Accordingly, we only need the subsets with cardinality 0, 1, p−1, p−2. The total number of function evaluations is 2(1+(p−1))=2p. When the order is 5 or 6, then q=2, we only need the subsets with cardinality 0, 1, 2, p−1, p−2 and p−3, and the total number of function evaluations is

$$2 ( 1 + ( p - 1 ) + ( \begin{matrix}p - 1 \\ 2\end{matrix} ) ) = 0 ( {p}^{2} ) .$$

This linear and quadratic time complexity is much faster than the exponential time consuming in EQ. 1 and EQ. 2.
Approximating SHAP with Model of Unknown Order

Using the order-K formula in Theorem 1 can be efficient to compute B-SHAP exactly when the model order is known and not high. In practice, however, we might not know the order of a model, or the order can be high but the high order interactions are small. In this case, we can approximate the SHAP values using an iterative way. Specifically, we start from computing SHAP with K=1. Then we increase the order to 2 and compute the difference between SHAP of order 2 and order 1. We keep increasing the order by 2 (since the formula is the same for K and K−1 when K is even and K≥4) until the difference between SHAP of order K and SHAP of order K−2 are small enough. Then we use the order-K result as our estimated SHAP. The reasoning behind this procedure is that if the model is approximately low-order, then the SHAP values won't change much when K reaches certain sufficiently large value. Note that using a higher order formula for a lower order model won't cause any error, so the results of order Kₜᵣᵤₑ+2 and order Kₜᵣᵤₑ are exactly the same, and the algorithm will always converge at order Kₜᵣᵤₑ+2 or earlier. This procedure is summarized in Table 1.

TABLE 1
Iterative way to compute SHAP

```
  Input: data to be explained, max_order, threshold
  current_order = 1, difference = positive infinity, converge = False
  while current_order ≤ max_order and difference > threshold:
    difference = mean(|SHAP of current order - SHAP of previous
  order|)²/Variance(SHAP of current order)
    if difference < threshold:
      converge = True
      return SHAP results, current_order and converge
    if current_order = 1:
      current_order += 1
    else:
      current_order += 2
  return SHAP results, current_order and converge
Output: SHAP results, order at convergence or max order, convergence (Boolean)
```

Note during the iterative procedure, it is possible that the SHAP values for most features and observations converge, but they do not converge on a few features for a few observations. The reason can be that these features might be involved in the high order interactions and the magnitudes of the high order terms are large for these observations. In that case, the algorithm can be further optimized to drop observations/features which have converged and focus on the ones which have not.

### Simulations

### Simulation Settings

In simulations of example embodiments, we consider models of order 2, 4 and 6. We compare Captum, the open source model interpretability library, with our exact methods using order-K and functional decomposition formula to estimate the error of the Captum method. We also examine how well the lower order approximation method works for the order-6 model. Below are the models considered:

$$Order - 2 model : {\sum }_{j = 1}^{10} {x}_{j} = 1 + {x}_{1} {x}_{2} + {x}_{3} {x}_{4} + {x}_{5} {x}_{6} + {x}_{7} {x}_{8}$$

$$Order - 4 model : {\sum }_{j = 1}^{10} {x}_{j} = 1 + {x}_{1} {x}_{2} + {x}_{3} {x}_{4} + {x}_{5} {x}_{6} + {x}_{7} {x}_{8} + {x}_{1} {x}_{2} {x}_{3} {x}_{4} + {x}_{5} {x}_{6} {x}_{7} {x}_{8}$$

$$Order - 6 model : {\sum }_{j = 1}^{10} {x}_{j} = 1 + {x}_{1} {x}_{2} + {x}_{3} {x}_{4} + {x}_{5} {x}_{6} + {x}_{7} {x}_{8} + {x}_{1} {x}_{2} {x}_{3} {x}_{4} + {x}_{5} {x}_{6} {x}_{7} {x}_{8} + α {x}_{1} {x}_{2} {x}_{3} {x}_{4} {x}_{5} {x}_{6}$$

For the order-6 model, the coefficients for the 6-way interaction term α are 0.5, 1 and 2 to reflect different levels of high-order interaction effect. The input variables are i.i.d. normal with mean 0 and variance 1, and 10000 observations are generated. Since the goal of the simulation is not model fitting, we use the true models and compute B-SHAP for the true models. When computing B-SHAP, we use all 10000 data points and compare them to two baseline points. The first choice of baseline is the average of the 10000 data points, and the second choice is the 97.5 percentile of each feature. The averages are close to 0 and the 97.5 percentiles are close to 1.96 because each feature is generated with a standard normal distribution.

### Simulation Results

### Accuracy Comparison

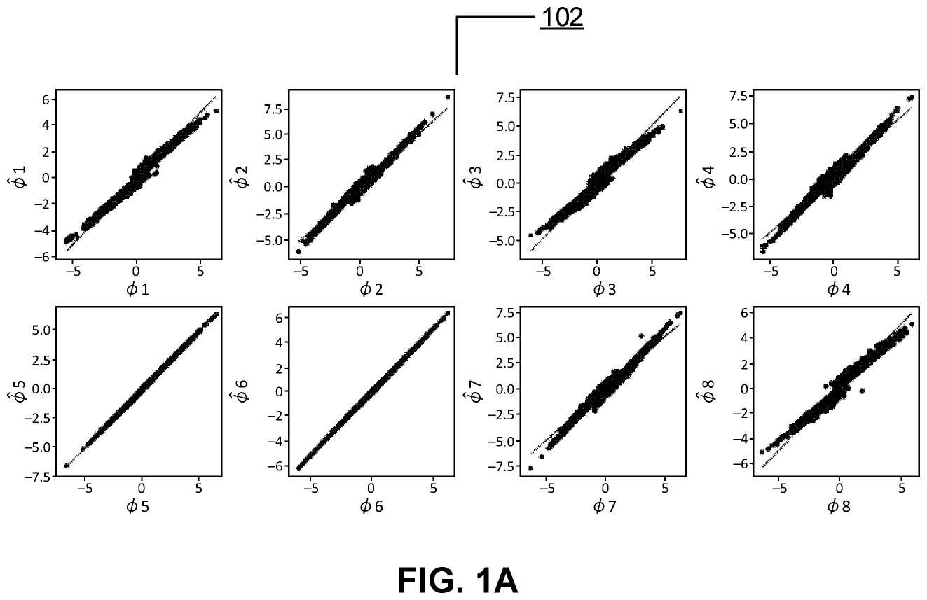

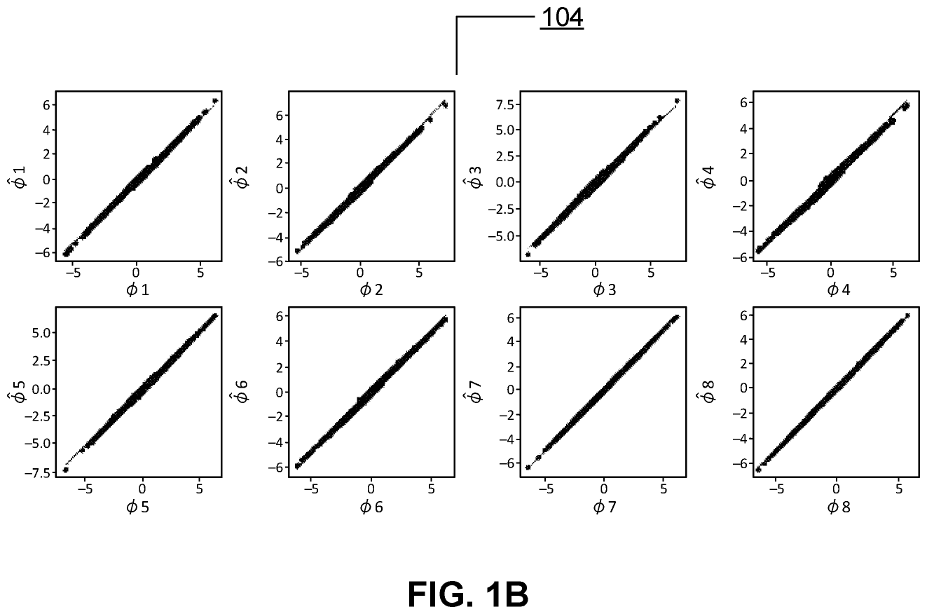

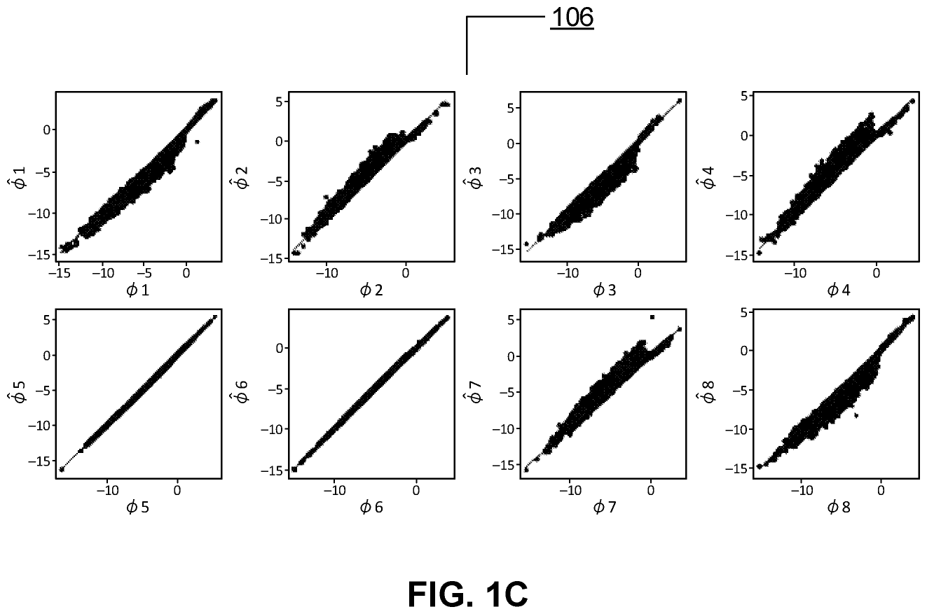

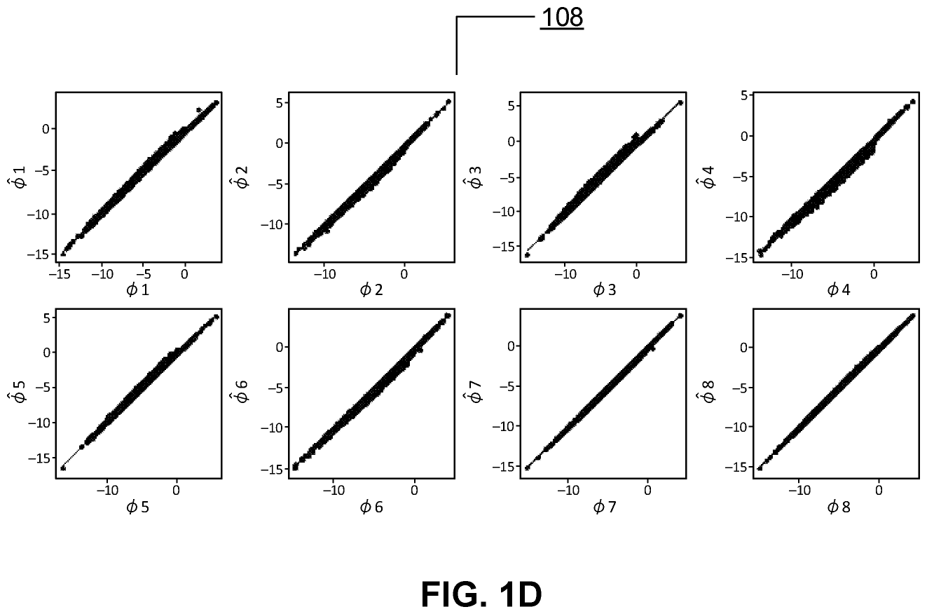

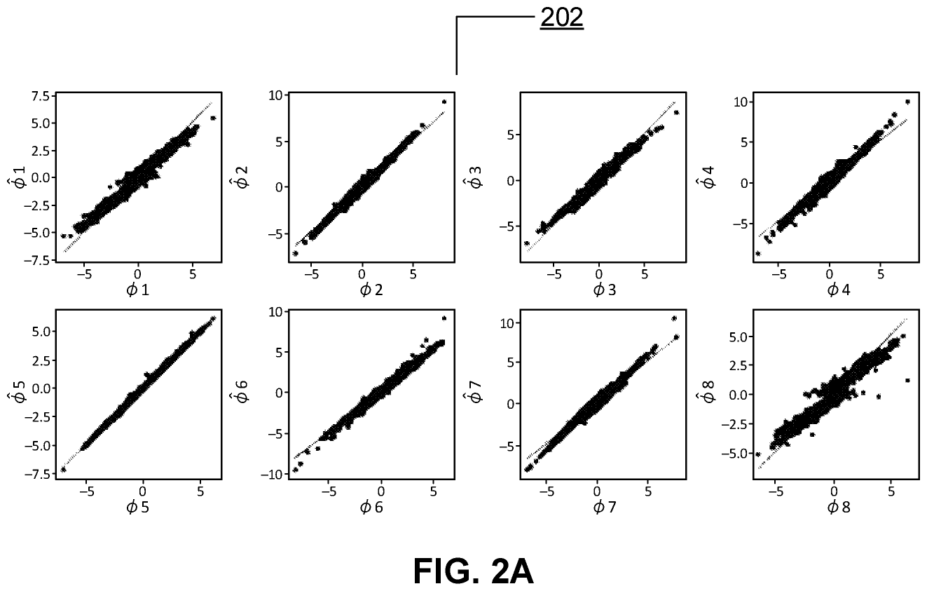

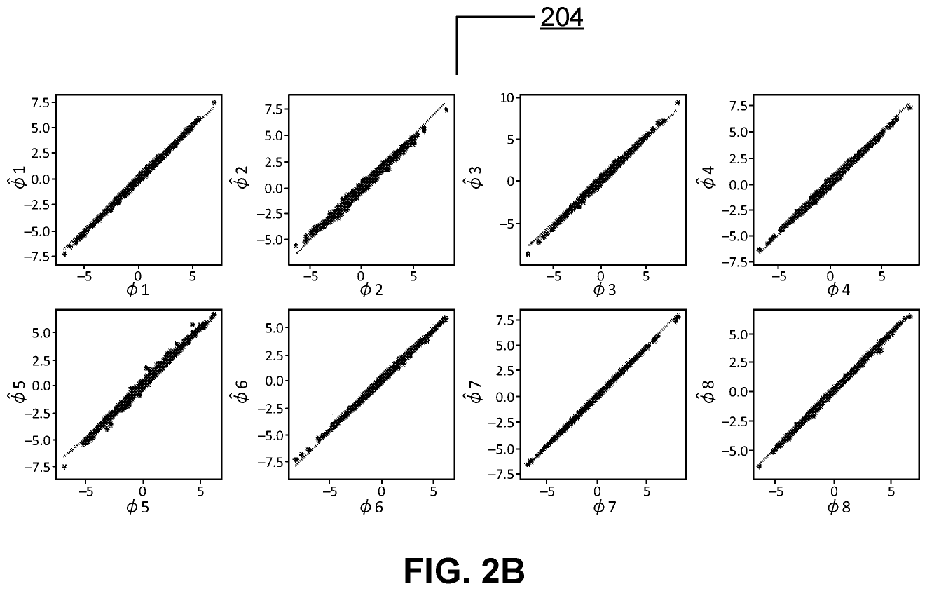

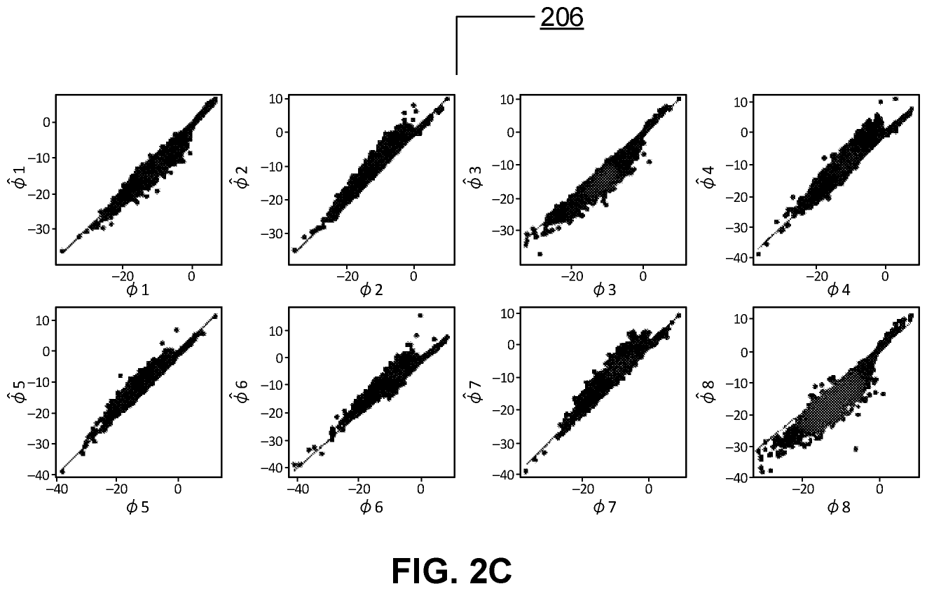

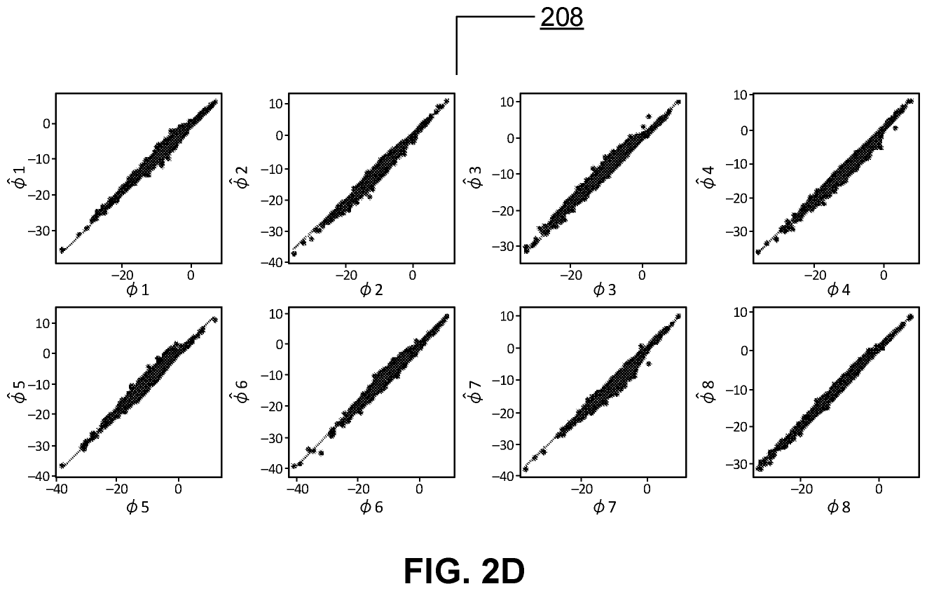

We first compare the accuracy of B-SHAP computed using the sampling method in Captum with the exact B-SHAP computed using order-K and functional decomposition (f-dcmp) formulas. We use 25 and 100 as the number of samples (subsets) in Captum. FIGS. 1A-1D and FIGS. 2A-2D show the comparison for order-2 and order-4 model respectively. The plots shown in FIG. 1A (including plots 102), FIG. 1B (including plots 104), FIG. 2A (including plots 202), and FIG. 2B (including plots 204), show the average baseline. The plots shown in FIG. 1C (including plots 106), FIG. 1D (including plots 108), FIG. 2C (including plots 206), and FIG. 2D (including plots 208) show the 97.5 percentile baseline. Plots 102, plots 106, plots 202, and plots 206 show the results with 25 samples and plots 104, plots 108, plots 204, and plots 208 show the results with 100 samples. Because SHAP values for main-effect only variables can always be estimated correctly, we do not include ϕ₉ and ϕ₁₀ in the figures. We can see that the sampling method does not perform well when the number of samples is 25 as some points are far from the true values. Note for this particular sample of 25 subsets, ϕ₅ and ϕ₆ are estimated with high accuracy for the order-2 model. This happens purely by chance; a change of random seed in Captum will result in ϕ₅ and ϕ₆ being estimated less accurately. When the number of samples increases to 100, the performance becomes better, yet small errors still exist. Moreover, the scale of error becomes larger when the baseline point is the 97.5 percentile. To explain this for the order-2 model, we first compute the error related with Captum sampling approach. Suppose we are interested in SHAP value for x₁. For any permutation S, we have

$$c ( f , {Pre}^{1} ( S ) + 1 ) − c ( f , {Pre}^{1} ( S ) ) = \{ \begin{matrix}( {x}_{1} − {z}_{1} ) ( 1 + {x}_{2} ) , if 2 ∈ {Pre}^{1} ( S ) \\ ( {x}_{1} − {z}_{1} ) ( 1 + {z}_{2} ) , if 2 ∉ {Pre}^{1} ( S )\end{matrix} .$$

Since the events 2∈Pre¹(S) and 2∉Pre¹(S) have equal probability, we have

$$E ( {\hat{ϕ}}_{1} ) = ( {x}_{1} - {z}_{1} ) ( 1 + \frac{{x}_{2} + {z}_{2}}{2} ) = {ϕ}_{1} ,$$

which is unbiased. The standard error is

$$Std ( {\hat{ϕ}}_{1} ) = \frac{\vert ( {x}_{1} - {z}_{1} ) ( {x}_{2} - {z}_{2} ) \vert}{\sqrt{4 m}} ,$$

where m is the number of samples. The numerator, |(x₁−z₁)(x₂−z₂)|, measures the strength of x₁x₂-interaction from the sample x to the reference point z. When (z₁,z₂) changes from the dense center (0,0) to the far extreme of 97.5 percentile (1.96,1.96), the interaction gets stronger for most observations, hence the overall standard error increases. The explanation for the order-4 model is similar but more cumbersome, so we omit it here. Note when we happen to have equal number of permutations between 2∈Pre¹(S) and 2∉Pre¹(S), ϕ₁ can be estimated precisely. This explains the high accuracy for \hat{ϕ}₅ and \hat{ϕ}₆ we see in FIGS. 1A-1D.

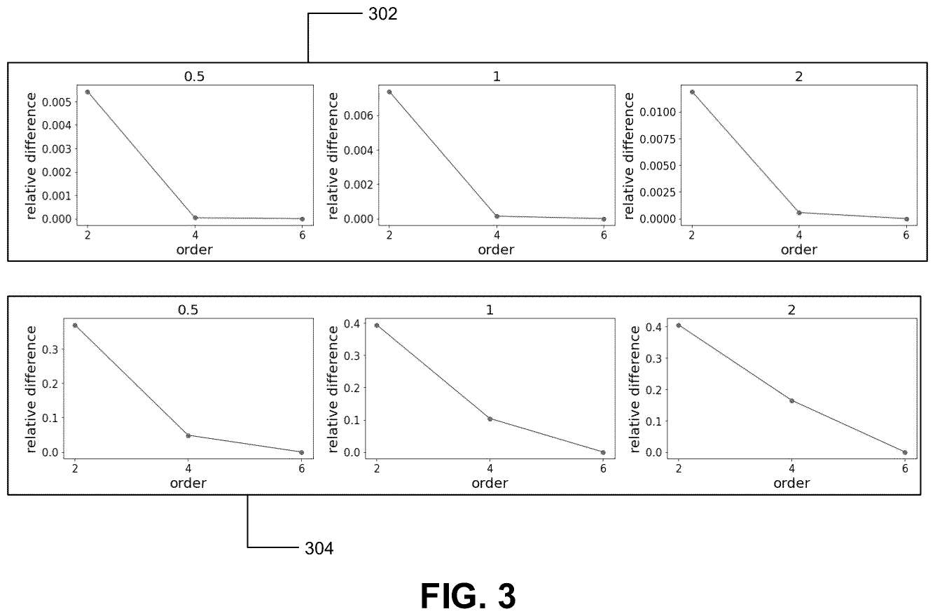

For the order-6 model, we choose different coefficients 0.5, 1 and 2 for the 6-way interaction. We still run the sampling method with number of samples 25 and 100. We then run the iterative method described under “Approximating SHAP with model of unknown order”. We set the max order in the iterative method as 10 because in practice it is rare to see interactions higher than that. Recall we use the relative difference to check convergence, where the relative difference is defined as mean(|SHAP of current order−SHAP of previous order|)²/Variance(SHAP of current order). We set the threshold for convergence to be 0.0001. When the coefficient is 0.5 and the baseline is the average, the iterative approach stops at order=6 because the relative difference between order-4 and order-6 SHAP values is smaller than the threshold. This indicates the 6-way interaction is weak. When the coefficient is 0.5 and the baseline is the 97.5 percentile, or when the coefficient is 1 or 2 regardless of baseline, the strength of 6-way interaction is stronger. Therefore, the 4th-order approximation has larger errors, and the iterative approach stops at order=8, meaning that the difference between order-4 approximation and order-6 approximation is larger than threshold, and the difference between order-6 and order-8 approximations is small (0). To further demonstrate this, we show the relative difference between SHAP values with different orders and the true SHAP values in FIG. 3. The top figures 302 have the average as the baseline and the bottom figures 304 use the 97.5 percentile. Since the relative difference at order 1 is much bigger than the rest (around 0.07 for the average baseline and larger than 50 for the 97.5 percentile baseline), our plots start from order 2 for better illustration. We can see that the relative differences decrease significantly when the order increases from 2 to 4 for all 3 coefficients. The relative differences are already close to 0 at order 4 when the baseline is average; however, they are much larger at order 4 when the baseline is the 97.5 percentile.

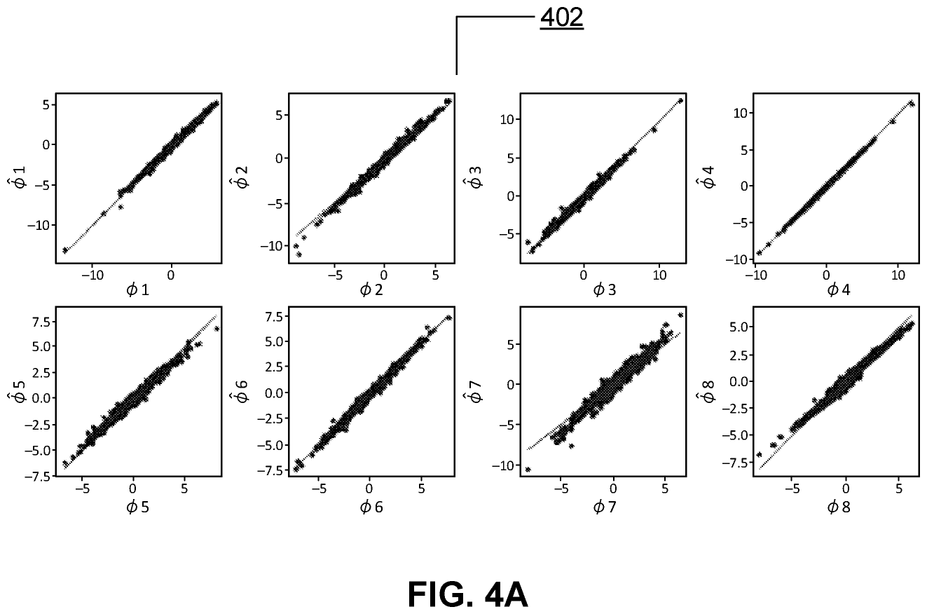

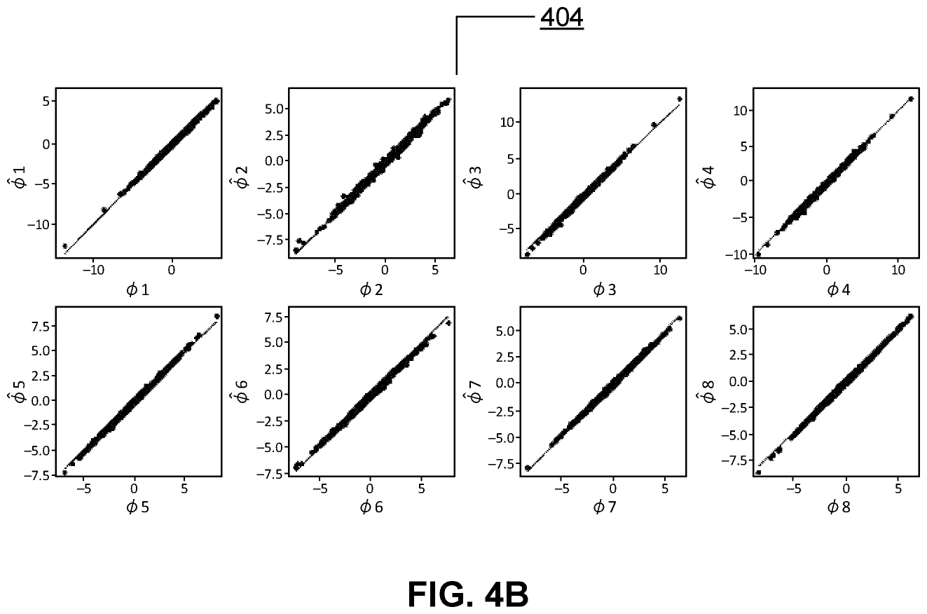

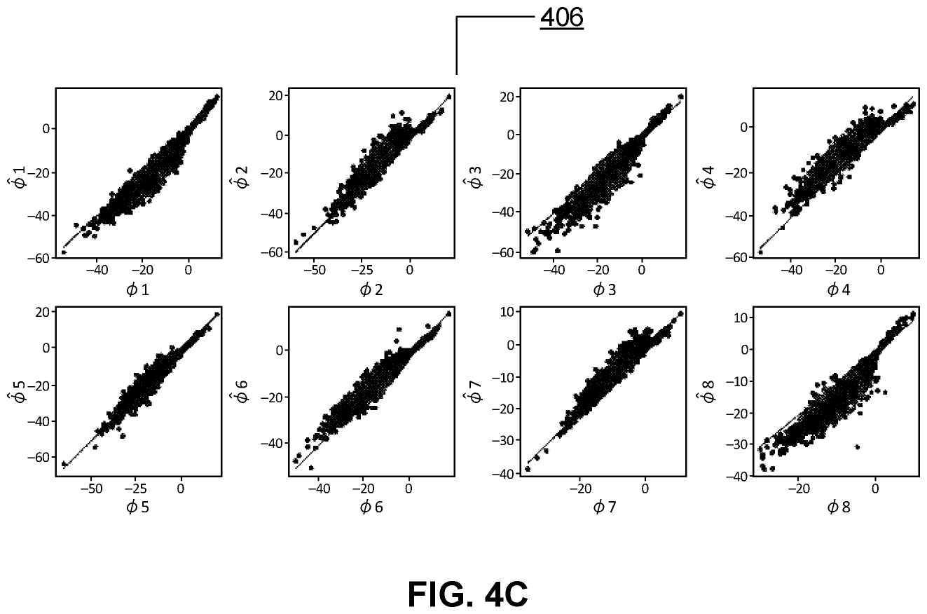

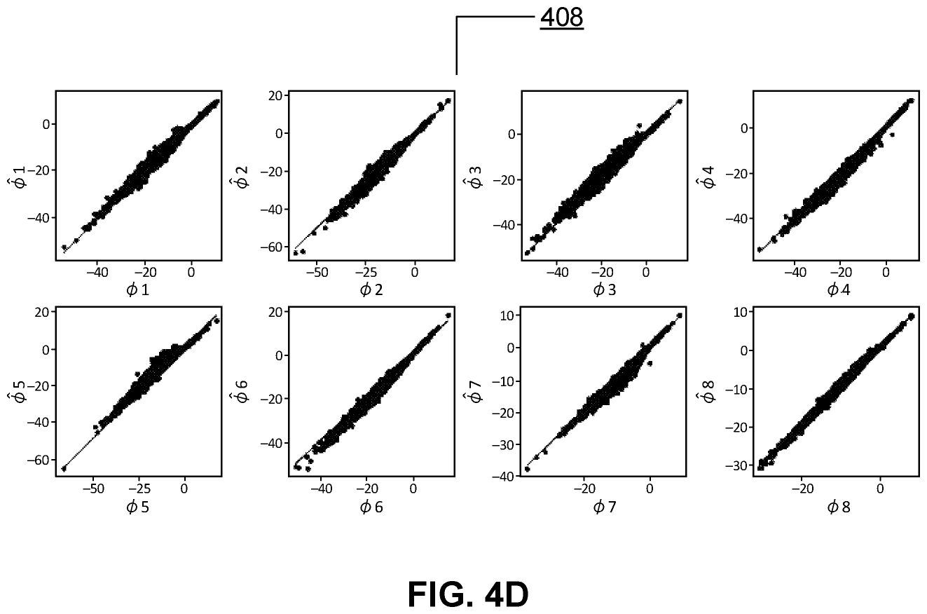

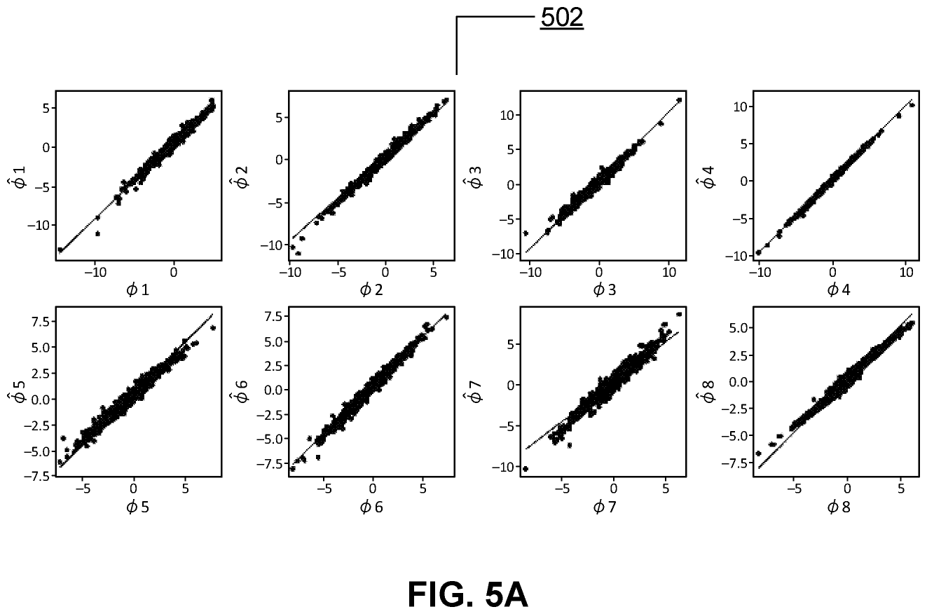

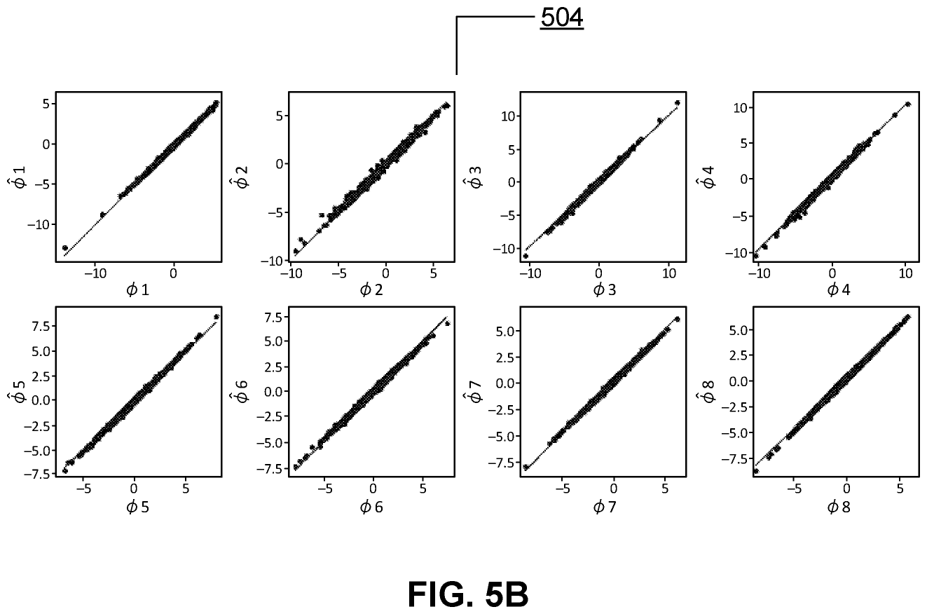

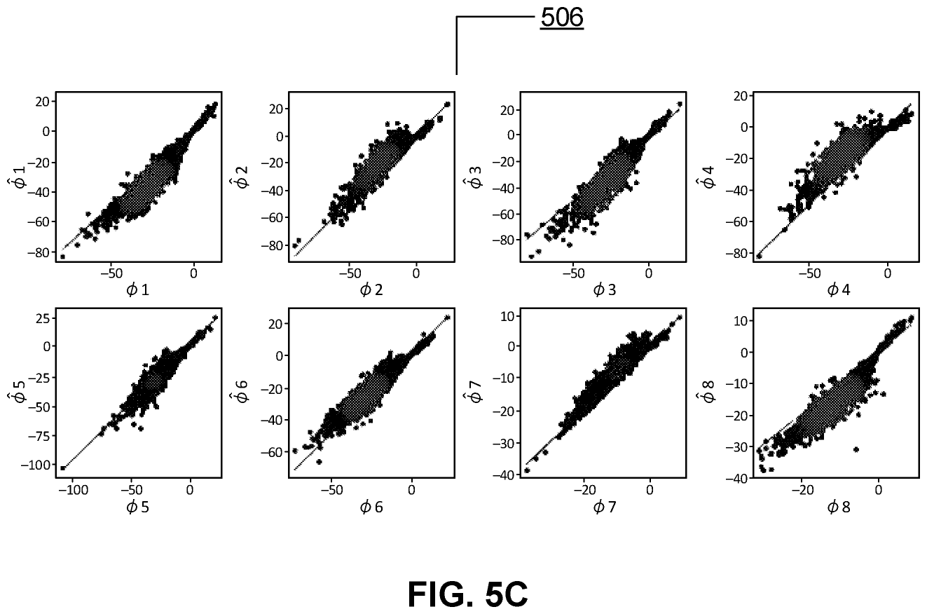

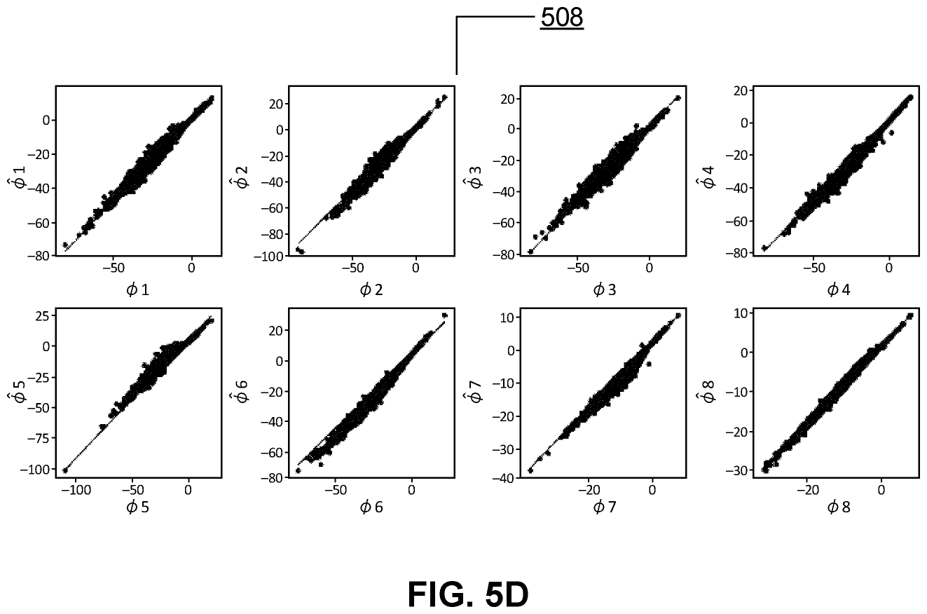

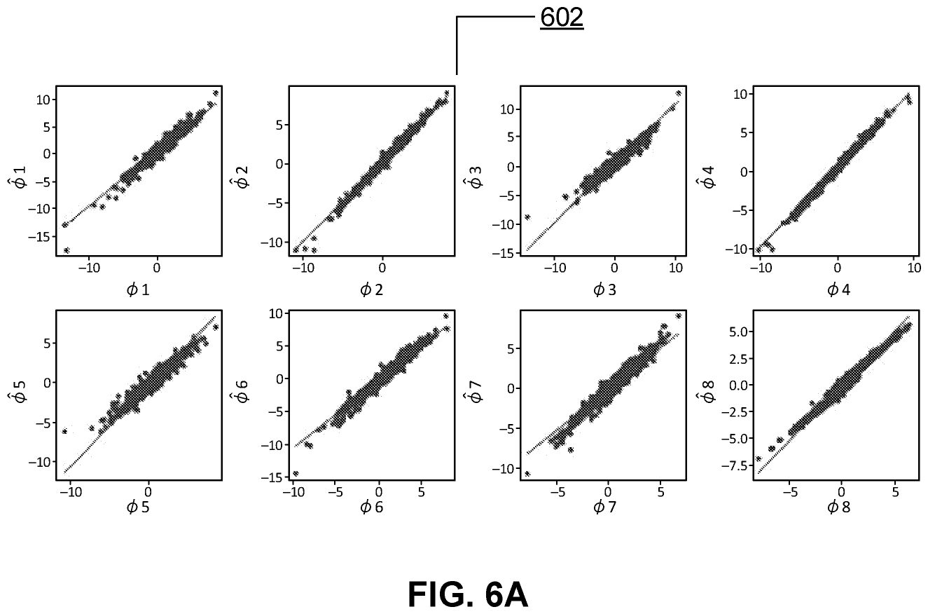

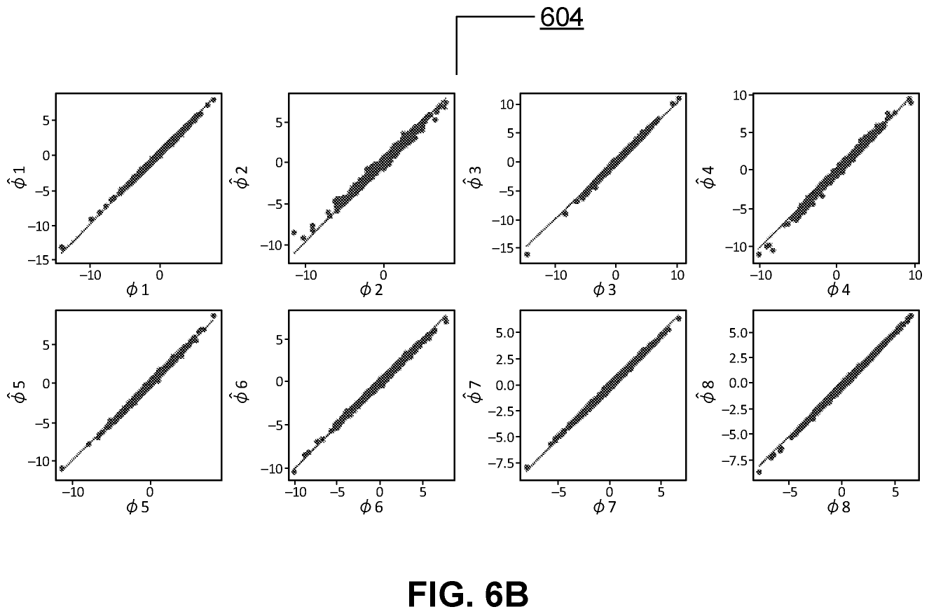

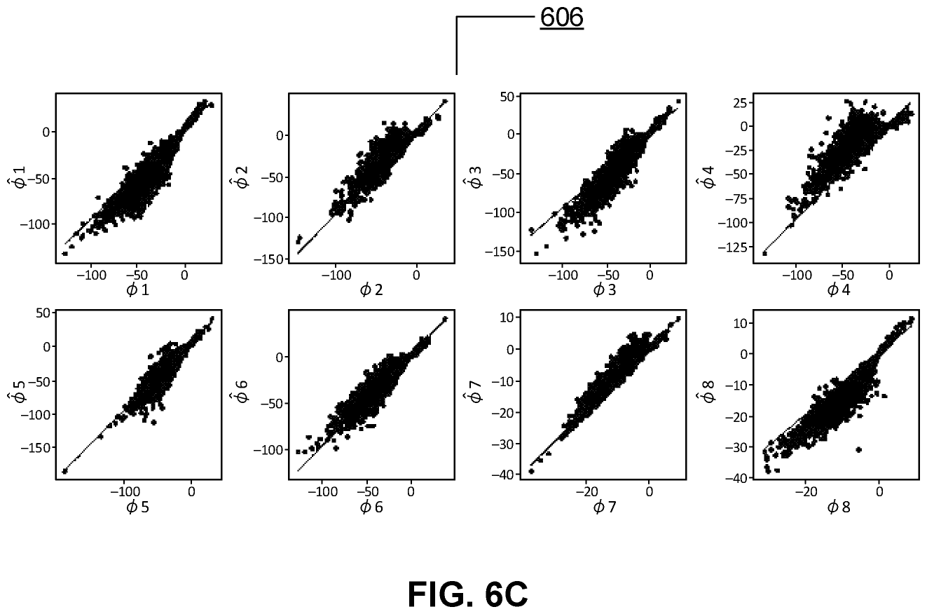

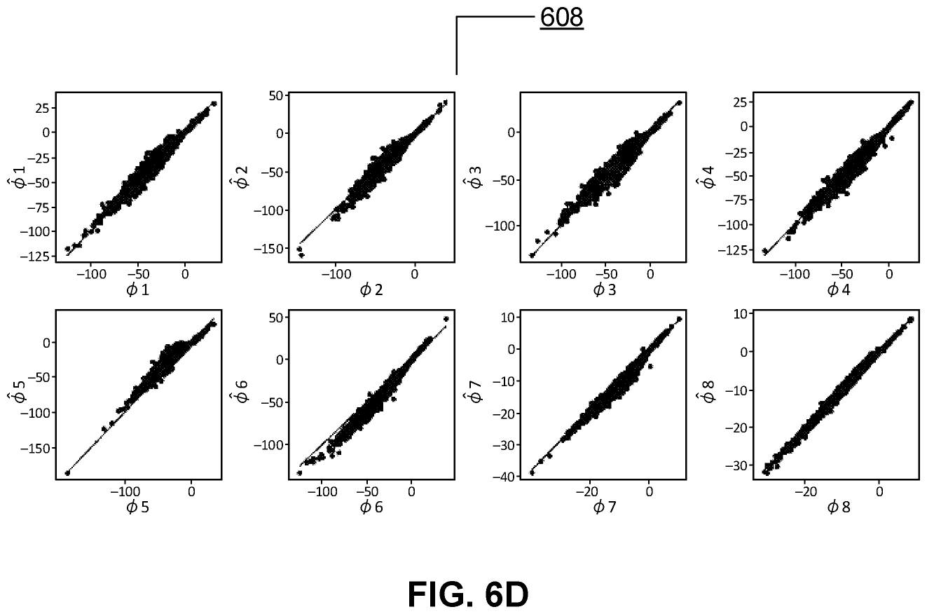

Finally, we compare the results of Captum method with our iterative algorithm. Since we set the convergence threshold to be very small (0.0001), our iterative algorithm stops at either order 6 or 8, both yielding the exact result. FIGS. 4-6 show the comparison of Captum method with our exact result for coefficient 0.5, 1 and 2 respectively. The plots shown in FIG. 4A (including plots 402), FIG. 4B (including plots 404), FIG. 5A (including plots 502), FIG. 5B (including plots 504), FIG. 6A (including plots 602), and FIG. 6B (including plots 604) use the average baseline. The plots shown in FIG. 4C (including plots 406), FIG. 4D (including plots 408), FIG. 5C (including plots 506), FIG. 5D (including plots 508), FIG. 6C (including plots 606), and FIG. 6D (including plots 608) use the 97.5 percentile as baseline. Plots 402, plots 406, plots 502, plots 506, plots 602, and plots 606 use 25 samples and the plots 404, plots 408, plots 504, plots 508, plots 604, and plots 608 use 100 samples. As we explained before, the interaction strength gets stronger when the baseline is the 97.5 percentile. Hence the errors in bottom plots are much larger than the top ones. Larger coefficients of high-way interactions also increase the interaction strength, thus we can see larger errors in FIGS. 5A-5D and 6A-6D than FIGS. 4A-4D.

### Speed Comparison

The speed of different methods of computing SHAP is measured and reported for some example embodiments. Note that speed is not only related with the method but also the numeric implementation. We did not apply any high-performance computing tools here so the speed should be considered as the baseline not the best scenario. We use the 10-variable models specified previously as well as three new models each with 10 more variables, (e.g., the order-2 model with 20 variables now becomes Σⱼ₌₁²⁰xⱼ=1+x₁x₂+x₃x₄+x₅x₆+x₇x₈). As before, we use all 10000 observations to compute B-SHAP. We show the results of using the average as the baseline in the speed comparison. The speeds of using the 97.5 percentile as baseline are very close to those of the average baseline; the only difference with average baseline is that when the model has 6-way interaction with coefficient 0.5, the iterative method stops at order 6 instead of 8. When applying the f-dcmp method, we assume that we know the model form, hence we compute the B-SHAP of each component using EQ. 1 and then add them up following Proposition 1. When using the order-K formula, we use the order of the true model. We use 25 and 100 as the sample sizes for Captum. For order-6 models, we also apply the iterative method. The max order is 10 and the threshold for the relative difference is 0.0001.

Table 2 and Table 3 show the time of running each method on the same computing platform with 10 and 20 variables respectively. We first notice that applying f-dcmp is fastest for almost all the models. Applying the order-K formula is faster than Captum-25 when the order is low and number of variables is small. When order is 6 and number of variables is 20, the order-K formula is slower than Captum-25 and close to Captum-2.3. Note that applying the order-K formula gives the exact results. Therefore, if we know the order of the model, using the order-K formula is a better choice than the sampling method in both accuracy and speed when the order is low, and the number of variables is not large. In the case that we do not know the order of the model and the high-order effect is small, e.g., with coefficient 0.5, we see that applying the iterative approach can be a good strategy. It is still faster than Captum-100 when there are 10 variables and as fast as Captum-100 for 20 variables. With strong high-order effect (coefficient 1 and 2), the iterative procedure stops at order 8, hence the time is longer than Captum-4.6.

TABLE 2
Time comparison for each method when the models have 10
variables. The time is in seconds.

| | Order 2 | Order 4 | Order 6-0.5 | Order 6-1 | Order 6-2 |
|---|---|---|---|---|---|
| f-dcmp | 0.066 | 0.17 | 0.5 | 0.48 | 0.52 |
| Order-K | 0.034 | 0.17 | 0.63 | 0.64 | 0.6 |
| Iterative | | | 0.59 | 1.33 | 1.24 |
| Captum-25 | 0.57 | 0.56 | 0.59 | 0.59 | 0.58 |
| Captum-100 | 2.35 | 2.18 | 2.34 | 2.25 | 2.39 |

TABLE 3
Time comparison for each method when the models have 20
variables. The time is in seconds.

| | Order 2 | Order 4 | Order 6-0.5 | Order 6-1 | Order 6-2 |
|---|---|---|---|---|---|
| f-dcmp | 0.1 | 0.21 | 0.54 | 0.53 | 0.5 |
| Order-K | 0.078 | 0.84 | 5.62 | 5.85 | 5.69 |
| Iterative | | | 5.41 | 26.8 | 25.28 |
| Captum-25 | 1.14 | 1.17 | 1.24 | 1.23 | 1.32 |
| Captum-100 | 4.61 | 4.6 | 5.01 | 5.04 | 5.17 |

### System Architecture

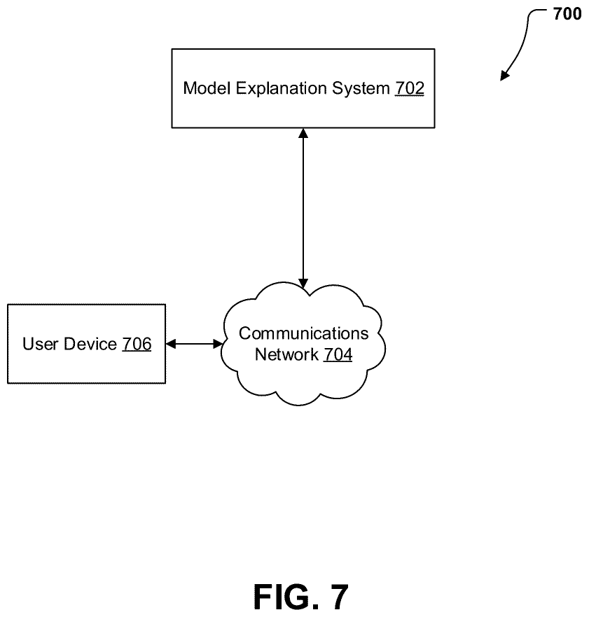

Example embodiments described herein may be implemented using any of a variety of computing devices or servers. To this end, FIG. 7 illustrates an example environment 700 within which various embodiments may operate. As illustrated, a model explanation system 702 may receive and/or transmit information via communications network 704 (e.g., the Internet) with any number of other devices, such as one or more user device 106.

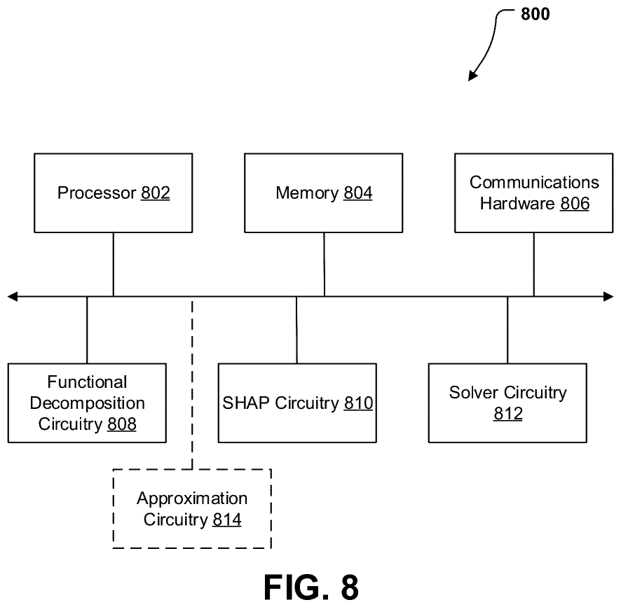

The model explanation system 702 may be implemented as one or more computing devices or servers, which may be composed of a series of components. Particular components of the model explanation system 702 are described in greater detail below with reference to apparatus 800 in connection with FIG. 8.

The user device 706 may be embodied by any computing devices known in the art. The user device 706 need not itself be an independent device, but may be a peripheral device communicatively coupled to other computing devices.

### Example Implementing Apparatuses

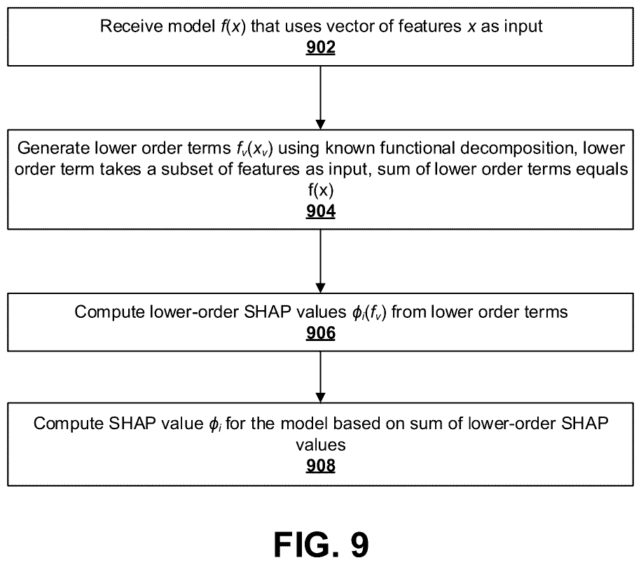

The model explanation system 702 (described previously with reference to FIG. 7) may be embodied by one or more computing devices or servers, shown as apparatus 800 in FIG. 8. The apparatus 800 may be configured to execute various operations described above in connection with FIG. 7 and below in connection with FIGS. 9-12. As illustrated in FIG. 8, the apparatus 800 may include processor 802, memory 804, communications hardware 806, functional decomposition circuitry 808, SHAP circuitry 810, solver circuitry 812, and approximation circuitry 814 each of which will be described in greater detail below.

The processor 802 (and/or co-processor or any other processor assisting or otherwise associated with the processor) may be in communication with the memory 804 via a bus for passing information amongst components of the apparatus. The processor 802 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 800, remote or “cloud” processors, or any combination thereof.

The processor 802 may be configured to execute software instructions stored in the memory 804 or otherwise accessible to the processor. In some cases, the processor may be configured to execute hard-coded functionality. As such, whether configured by hardware or software methods, or by a combination of hardware with software, the processor 802 represent an entity (e.g., physically embodied in circuitry) capable of performing operations according to various embodiments of the present invention while configured accordingly. Alternatively, as another example, when the processor 802 is embodied as an executor of software instructions, the software instructions may specifically configure the processor 802 to perform the algorithms and/or operations described herein when the software instructions are executed.

Memory 804 is non-transitory and may include, for example, one or more volatile and/or non-volatile memories. In other words, for example, the memory 804 may be an electronic storage device (e.g., a computer readable storage medium). The memory 804 may be configured to store information, data, content, applications, software instructions, or the like, for enabling the apparatus to carry out various functions in accordance with example embodiments contemplated herein.

The communications hardware 806 may be any means such as a device or circuitry embodied in either hardware or a combination of hardware and software that is configured to receive and/or transmit data from/to a network and/or any other device, circuitry, or module in communication with the apparatus 800. In this regard, the communications hardware 806 may include, for example, a network interface for enabling communications with a wired or wireless communication network. For example, the communications hardware 806 may include one or more network interface cards, antennas, buses, switches, routers, modems, and supporting hardware and/or software, or any other device suitable for enabling communications via a network. Furthermore, the communications hardware 806 may include the processing circuitry for causing transmission of such signals to a network or for handling receipt of signals received from a network.

The communications hardware 806 may further be configured to provide output to a user and, in some embodiments, to receive an indication of user input. In this regard, the communications hardware 806 may comprise a user interface, such as a display, and may further comprise the components that govern use of the user interface, such as a web browser, mobile application, dedicated client device, or the like. In some embodiments, the communications hardware 806 may include a keyboard, a mouse, a touch screen, touch areas, soft keys, a microphone, a speaker, and/or other input/output mechanisms. The communications hardware 806 may utilize the processor 802 to control one or more functions of one or more of these user interface elements through software instructions (e.g., application software and/or system software, such as firmware) stored on a memory (e.g., memory 804) accessible to the processor 802.

In addition, the apparatus 800 further comprises a functional decomposition circuitry 808 that generates a set of lower order terms using a functional decomposition of a model. The functional decomposition circuitry 808 may utilize processor 802, memory 804, or any other hardware component included in the apparatus 800 to perform these operations, as described in connection with FIGS. 9-12 below. The functional decomposition circuitry 808 may further utilize communications hardware 806 to gather data from a variety of sources (e.g., user device 106, as shown in FIG. 7), and/or exchange data with a user, and in some embodiments may utilize processor 802 and/or memory 804 to decompose a model.

In addition, the apparatus 800 further comprises a SHAP circuitry 810 that computes lower-order SHAP values for a set of lower-order terms, computes a SHAP value based on lower-order terms, determines an order for a SHAP value, determines the set u, and computes ϕᵢ. for a given model order. The SHAP circuitry 810 may utilize processor 802, memory 804, or any other hardware component included in the apparatus 800 to perform these operations, as described in connection with FIGS. 9-12 below. The SHAP circuitry 810 may further utilize communications hardware 806 to gather data from a variety of sources (e.g., user device 706, as shown in FIG. 7), and/or exchange data with a user, and in some embodiments may utilize processor 802 and/or memory 804 to compute SHAP values.

Further, the apparatus 800 further comprises a solver circuitry 812 that solves a system of equations to determine coefficients for determining a SHAP value. The solver circuitry 812 may utilize processor 802, memory 804, or any other hardware component included in the apparatus 800 to perform these operations, as described in connection with FIGS. 9-12 below. The solver circuitry 812 may further utilize communications hardware 806 to gather data from a variety of sources (e.g., user device 706, as shown in FIG. 7), and/or exchange data with a user, and in some embodiments may utilize processor 802 and/or memory 804 to solve equations.

Finally, the apparatus 800 may further comprise an approximation circuitry 814 that iterate a sequence of steps, compute a difference and compare the difference to a threshold to determine if iteration is stopped. The approximation circuitry 814 may utilize processor 802, memory 804, or any other hardware component included in the apparatus 800 to perform these operations, as described in connection with FIGS. 9-12 below. The approximation circuitry 814 may further utilize communications hardware 806 to gather data from a variety of sources (e.g., user device 706, as shown in FIG. 7), and/or exchange data with a user, and in some embodiments may utilize processor 802 and/or memory 804 to iteratively approximate a SHAP value.

Although components 802-814 are described in part using functional language, it will be understood that the particular implementations necessarily include the use of particular hardware. It should also be understood that certain of these components 802-814 may include similar or common hardware. For example, the functional decomposition circuitry 808, SHAP circuitry 810, solver circuitry 812, and approximation circuitry 814 may each at times leverage use of the processor 802, memory 804, or communications hardware 806, such that duplicate hardware is not required to facilitate operation of these physical elements of the apparatus 800 (although dedicated hardware elements may be used for any of these components in some embodiments, such as those in which enhanced parallelism may be desired). Use of the terms “circuitry” with respect to elements of the apparatus therefore shall be interpreted as necessarily including the particular hardware configured to perform the functions associated with the particular element being described. Of course, while the terms “circuitry” should be understood broadly to include hardware, in some embodiments, the terms “circuitry” may in addition refer to software instructions that configure the hardware components of the apparatus 800 to perform the various functions described herein.

Although the functional decomposition circuitry 808, SHAP circuitry 810, solver circuitry 812, and approximation circuitry 814 may leverage processor 802, memory 804, or communications hardware 806 as described above, it will be understood that any of functional decomposition circuitry 808, SHAP circuitry 810, solver circuitry 812, and approximation circuitry 814 may include one or more dedicated processor, specially configured field programmable gate array (FPGA), or application specific interface circuit (ASIC) to perform its corresponding functions, and may accordingly leverage processor 802 executing software stored in a memory (e.g., memory 804), or communications hardware 806 for enabling any functions not performed by special-purpose hardware. In all embodiments, however, it will be understood that functional decomposition circuitry 808, SHAP circuitry 810, solver circuitry 812, and approximation circuitry 814 comprise particular machinery designed for performing the functions described herein in connection with such elements of apparatus 800.

In some embodiments, various components of the apparatus 800 may be hosted remotely (e.g., by one or more cloud servers) and thus need not physically reside on the corresponding apparatus 800. For instance, some components of the apparatus 800 may not be physically proximate to the other components of apparatus 800. Similarly, some or all of the functionality described herein may be provided by third party circuitry. For example, a given apparatus 800 may access one or more third party circuitries in place of local circuitries for performing certain functions.

As will be appreciated based on this disclosure, example embodiments contemplated herein may be implemented by an apparatus 800. Furthermore, some example embodiments may take the form of a computer program product comprising software instructions stored on at least one non-transitory computer-readable storage medium (e.g., memory 804). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 800 as described in FIG. 8, that loading the software instructions onto a computing device or apparatus produces a special-purpose machine comprising the means for implementing various functions described herein.

Having described specific components of example apparatus 800, example embodiments are described below in connection with a series of flowcharts.

### Example Operations

Turning to FIGS. 9-12, example flowcharts are illustrated that contain example operations implemented by example embodiments described herein. The operations illustrated in FIGS. 9-12 may, for example, be performed by the model explanation system 702 shown in FIG. 7, which may in turn be embodied by an apparatus 800, which is shown and described in connection with FIG. 8. To perform the operations described below, the apparatus 800 may utilize one or more of processor 802, memory 804, communications hardware 806, functional decomposition circuitry 808, SHAP circuitry 810, solver circuitry 812, approximation circuitry 814, and/or any combination thereof. It will be understood that user interaction with the model explanation system 702 may occur directly via communications hardware 806, or may instead be facilitated by a separate user device 706, as shown in FIG. 7, and which may have similar or equivalent physical componentry facilitating such user interaction.

Turning first to FIG. 9, example operations are shown for computing SHAP using model structure information. As shown by operation 902, the apparatus 800 includes means, such as processor 802, memory 804, communications hardware 806, or the like, for receiving a model ƒ(x) that uses a vector of features x as input, wherein the model has a known functional decomposition. The model ƒ(x) may be any fitted machine learning model that takes a p-dimensional vector x as input. The p-dimensional vector x may comprise values of p input features, and the set of input features may be referred to as the set M. Further requirements on properties of the model ƒ(x) may or may not exist depending on the embodiment, but various embodiments described herein may depend on whether a functional decomposition of ƒ(x) is known and/or able to be expressed.

In some embodiments, the known functional decomposition of the model is the functional ANOVA (fANOVA) decomposition. As described previously, fANOVA imposes hierarchical orthogonality constraints among its components to guarantee a unique decomposition, ∫ƒᵤ(xᵤ)ƒᵥ(xᵥ)w(x)dx=0, ∀u⊂v and w(x) is the joint distribution of predictors. Example embodiments may use any decomposition (not only fANOVA).

The communications hardware 806 may receive the model via attached hardware and/or via user device 706. The model may also be previously stored in memory 804 and retrieved for processing.

As shown by operation 904, the apparatus 800 includes means, such as processor 802, memory 804, functional decomposition circuitry 808, or the like, for generating, using the known functional decomposition, a set of lower order terms ƒᵥ(xᵥ), wherein a lower order term from the set of lower order terms takes a subset of the features as input, wherein a sum of the set of lower order terms equals the model ƒ(x). The decomposition of ƒ(x) is described above in connection with Proposition 1. In some embodiments, the lower order term from the set of lower order terms is expressed in a form Σ_{v⊆M} ƒᵥ(xᵥ), wherein M is a set of the features. As described previously, the functional decomposition circuitry 808 may prepare the decomposition of ƒ(x) into lower order terms may using any functional decomposition, for example, fANOVA.

As shown by operation 306, the apparatus 800 includes means, such as processor 802, memory 804, SHAP circuitry 810, or the like, for computing a set of lower-order SHAP values ϕᵢ(ƒᵥ) for the set of lower order terms. The SHAP circuitry 810 may compute the lower-order SHAP values by applying a SHAP definition as discussed previously in connection with Proposition 1 and Shapley values. The SHAP definition may include a cost function, and the cost function may satisfy certain requirements in connection with Proposition 1. In some embodiments, the set of lower-order SHAP values are computed using a cost function c(ƒ,u), wherein for c(ƒ,u) c(ƒ₁+ƒ₂,u)=c(ƒ₁,u)+c(ƒ₂,u), and in an instance in which ƒ(x)=ƒᵥ(xᵥ) and ƒ(x) only depends on xᵥ, c(ƒᵥ,u)=c(ƒᵥ,u∩v).

In some embodiments, the cost function is a B-SHAP cost function. The SHAP definition may be a B-SHAP or Baseline Shapley approach. In some embodiments, the cost function is a kernel SHAP cost function. The SHAP definition may be a kernel SHAP approach.

Finally, as shown by operation 908, the apparatus 800 includes means, such as processor 802, memory 804, SHAP circuitry 810, or the like, for computing, by the SHAP circuitry, a SHAP value ϕᵢ for the model based on a sum of the set of lower-order SHAP values. As described previously, if the model ƒ(x)=Σ_{v⊆M}ƒᵥ(xᵥ) and Assumption 1 holds, then ϕᵢ=Σ_{iεv}ϕᵢ(ƒᵥ), where the ϕᵢ(ƒᵥ) are the lower-order SHAP values from the set of lower-order SHAP values. The sum of the lower-order SHAP values may be performed by summing over all subsets v of the set M (the set of all features), where each lower-order terms of the function decomposition each take features from a subset v of the set M as input.

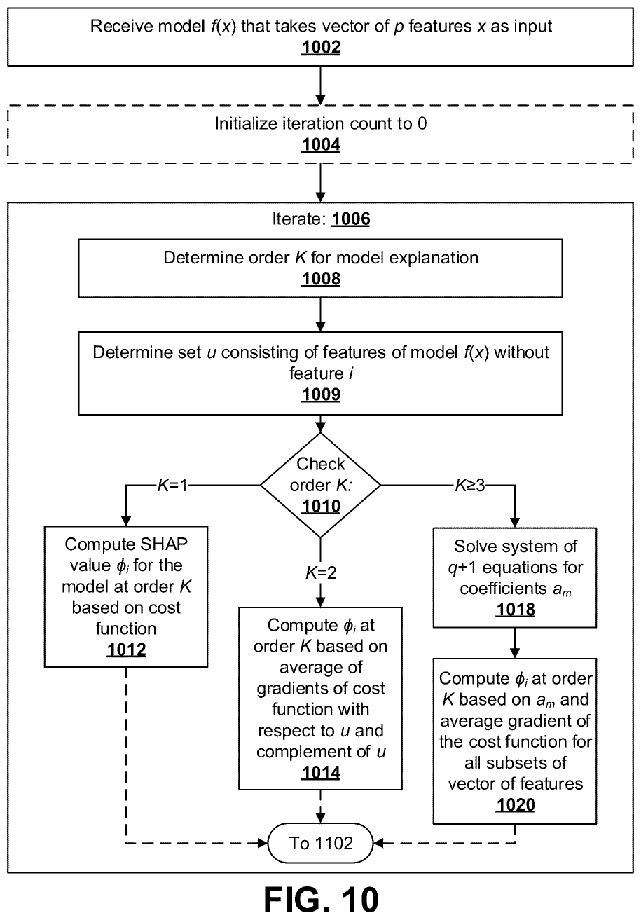

Turning now to FIG. 10, example operations are shown for computing SHAP using model structure information. As shown by operation 1002, the apparatus 800 includes means, such as processor 802, memory 804, communications hardware 806, or the like, for receiving a model ƒ(x) that takes a vector of p features x as input. The model ƒ(x) may be any fitted machine learning model that takes a p-dimensional vector x as input. The p-dimensional vector x may comprise values of p input features, and the set of input features may be referred to as the set M. Further requirements on properties of the model ƒ(x) may or may not exist depending on the embodiment, but various embodiments described herein may depend on whether a functional decomposition of ƒ(x) is known and/or able to be expressed.

In some embodiments, the known functional decomposition of the model is the functional ANOVA (fANOVA) decomposition. As described previously, fANOVA imposes hierarchical orthogonality constraints among its components to guarantee a unique decomposition, ∫ƒᵤ(xᵤ)ƒᵥ(xᵥ)w(x)dx=0, ∀u⊂v and w(x) is the joint distribution of predictors. Example embodiments may use any decomposition (not only fANOVA).

The communications hardware 806 may receive the model via attached hardware and/or via user device 706. The model may also be previously stored in memory 804 and retrieved for processing.

As shown by operation 1004, the apparatus 800 may include means, such as processor 802, memory 804, communications hardware 806, or the like, for initializing an iteration count to 0. The iteration count may be initialized to zero in an instance in which the operations iterated in accordance with operation 406 are used in an iterative approximation method. In an instance in which an exact SHAP value is computed (e.g., Computing SHAP with a model of known order, as described previously), multiple iterations may not be required, and the iteration may be performed only a single time. In an instance in which the iteration is performed a single time, an iteration counter may not be needed, and the iteration counter may not be initialized.

As shown by operation 1006, the apparatus 800 includes means, such as processor 802, memory 804, functional decomposition circuitry 808, SHAP circuitry 810, solver circuitry 812, approximation circuitry 814 or the like, for iterating a sequence of steps. As described previously, the iteration count may be initialized to zero in an instance in which the operations iterated in accordance with operation 406 are used in an iterative approximation method. In an instance in which an exact SHAP value is computed (e.g., Computing SHAP with a model of known order, as described previously), multiple iterations may not be required, and the iteration may be performed only a single time. The iteration of steps may include operation 1008 through operation 1020. In an instance in which an iterative approximation is used (e.g., Computing SHAP with a model of unknown order), the operations shown in FIG. 10 may also be iterated (operation 902 through operation 910) immediately after operations 1008-1020. In an instance in which an exact SHAP value is computed and only a single iteration is required (e.g., Computing SHAP with a model of known order), operations 1008-1020 may be iterated, and the operations of FIG. 10 may not necessarily be iterated, as only a single iteration may be performed.

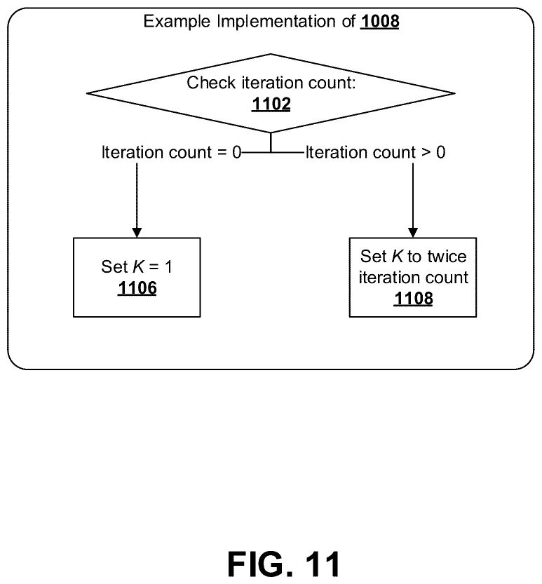

As shown by operation 1008, the apparatus 800 includes means, such as processor 802, memory 804, communications hardware 806, SHAP circuitry 810, or the like, for determining an order K for the model explanation. An example implementation of operation 1008 is shown in and described in connection with FIG. 11. In an instance in which an exact SHAP value is computed (e.g., Computing SHAP with a model of known order, described previously), the order K may be the known order of the model ƒ(x).

As shown by operation 1009, the apparatus 800 includes means, such as processor 802, memory 804, communications hardware 806, SHAP circuitry 810, or the like, for determining a set u consisting of features of the model ƒ(x) without a feature i. The SHAP circuitry 810 may use the set u to compute the SHAP value ϕᵢ for the feature i. The set u may be used in computations, for example, described below in connection with operation 1012 through operation 1020.

As shown by decision block 1010, control may flow to operation 1012, operation 1014, or operation 1018 depending on the order K for the model explanation. In an instance in which the order K is equal to one, control may flow to operation 1012. In an instance in which the order K is equal to two, control may flow to operation 1014. In an instance in which the order K is greater than or equal to three, control may flow to operation 1018.

As shown by operation 1012, the apparatus 800 includes means, such as processor 802, memory 804, SHAP circuitry 810, or the like, for in an instance in which K=1, computing a SHAP value ϕᵢ for the model at order K based on a cost function depending on the model, the set u, and the feature i. The SHAP circuitry 810 may use the gradient definition given previously, for any subset u⊆M\i,

$${ϕ}_{i} = c ( f , u + i ) - c ( f , u ) .$$

As shown by operation 1014, the apparatus 800 includes means, such as processor 802, memory 804, SHAP circuitry 810, or the like, for in an instance in which K=2, computing ϕᵢ at order K based on an average of gradients of the cost function with respect to the set u and a complement of u. The SHAP circuitry 810 may use the average gradients described previously, for any subset u⊆M\i,

$${ϕ}_{i} = \frac{1}{2} ( c ( f , u + i ) − c ( f , u ) + c ( f , \overline{u} ) − c ( f , \overline{u + l} ) ) , \overline{u} = M ∖ u .$$

In other words, ϕᵢ is the average of gradients with respect to any set u and its complement set u̅+̅i̅.

As shown by operation 1016, the apparatus 800 includes means, such as processor 802, memory 804, solver circuitry 812, or the like, for in an instance in which K≥3, solving a system of q+1 equations for a set of coefficients aₘ wherein q is the floor of (K−1)/2, wherein the system of equations depends on p. The solver circuitry 812 may use the system of equations given previously, in EQ. 3 to determine the coefficients aₘ.

As shown by operation 1018, the apparatus 800 includes means, such as processor 802, memory 804, SHAP circuitry 810, or the like, for in an instance in which K≥3, computing ϕᵢ at order K based on the set of coefficients aₘ and an average gradient of the cost function for all subsets of the vector of p features. Provided with the coefficients aₘ, the SHAP circuitry 810 may use the definition given previously,

$${ϕ}_{i} = {\sum }_{m = 0}^{q} {a}_{m} ( {d}_{m} + {d}_{p - m - 1} ) ,$$

where q=└(K−1)/2┘, └ ┘ is the floor function, and

$${d}_{m} = \frac{1}{( \begin{matrix}p - 1 \\ m\end{matrix} )} {\sum }_{u : \vert u \vert = m , u ⊆ M ∖ i} ( c ( f , u + i ) - c ( f , u ) ) .$$

In some embodiments, operation 1008 may be performed in accordance with the operations described by FIG. 11. Turning now to FIG. 11, example operations are shown for determining the order K for the model explanation. As shown by decision block 1102, control may flow to operation 1104 or 1106 depending on the iteration count. In an instance in which the iteration count is equal to zero, control may flow to operation 1104. In an instance in which the iteration count is greater than zero, control may pass to operation 1106. The iteration count may be initialized, for example, in operation 1004, and may be incremented in operation 1106.

As shown by operation 1104, the apparatus 800 includes means, such as processor 802, memory 804, communications hardware 806, SHAP circuitry 810, or the like, for setting K equal to one. As described previously for approximating SHAP with a model of unknown order, the first iteration for approximating SHAP may use model order equal to one.

Finally, as shown by operation 1106, the apparatus 800 includes means, such as processor 802, memory 804, communications hardware 806, SHAP circuitry 810, or the like, for setting K equal to twice the value of the iteration count. As described previously for approximating SHAP with a model of unknown order, subsequent iterations after the first iteration for approximating SHAP may use model order equal twice the current iteration. In other words, the model order may increment by one if the previous order was equal to one, and my increment by two if the previous order was not equal to one, as described in Table 1.

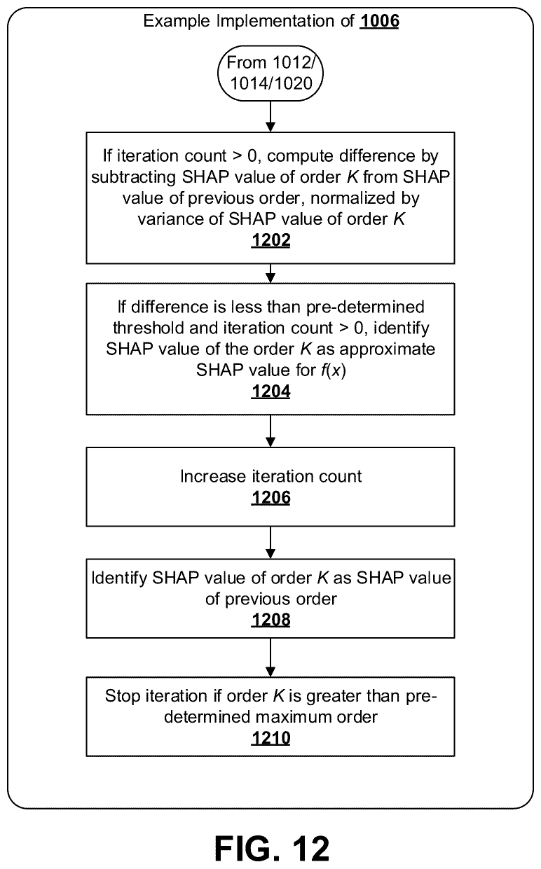

In some embodiments, operation 1006 may be performed in accordance with the operations described by FIG. 12. Turning next to FIG. 12, example operations are shown for iterating through a sequence of steps. As described previously, the operations of FIG. 12 may be performed following the operations of FIG. 10 in an instance in which an approximation of a SHAP value is performed using a model of unknown order. The operations of FIG. 12 follow the summary given in Table 1.

As shown by operation 1202, the apparatus 800 includes means, such as processor 202, memory 804, communications hardware 806, approximation circuitry 814, or the like, for in an instance in which the iteration count is greater than 0, computing a difference by subtracting a SHAP value of the order K from a SHAP value of a previous order, normalized by a variance of the SHAP value of the order K. For example, the difference may be expressed as difference=mean(|SHAP of current order−SHAP of previous order|)₂/Variance(SHAP of current order). The approximation circuitry 814 may compute the difference for iterations following the first iteration, when a current SHAP and a previous SHAP are available for the difference calculation.

As shown by operation 1204, the apparatus 800 includes means, such as processor 202, memory 804, communications hardware 806, approximation circuitry 814, or the like, for in an instance in which the difference is less than a pre-determined threshold and the iteration count is greater than 0, identifying the SHAP value of the order K as an approximate SHAP value ϕᵢ for the model ƒ(x). The approximation circuitry 814 may use the difference computed, for example, in connection with operation 1202, compared to the pre-determined threshold to determine if the approximation has reached a stopping point. In some embodiments, execution of the iteration may stop after the difference is less than the pre-determined threshold. The pre-determined threshold may be set using input from a user device 706, a stored value in memory 804, or received from communications hardware 806.

As shown by operation 1206, the apparatus 800 includes means, such as processor 202, memory 804, communications hardware 806, approximation circuitry 814, or the like, for increasing the iteration count. The approximation circuitry 814 may increase the iteration count following the initialization of the iteration count, for example, in operation 1004.

As shown by operation 1208, the apparatus 800 includes means, such as processor 202, memory 804, communications hardware 806, approximation circuitry 814, or the like, for identifying the SHAP value of the order K as the SHAP value of the previous order. The approximation circuitry 814 may prepare for a subsequent iteration my moving values of the current iteration to store as values of a previous iteration. Accordingly, the SHAP value of the order K may be identified as the SHAP value of the previous order during the subsequent iteration.

Finally, as shown by operation 1210, the apparatus 800 includes means, such as processor 802, memory 804, communications hardware 806, approximation circuitry 814, or the like, for in an instance in which the order K is greater than a pre-determined maximum order, stopping the iteration. The approximation circuitry 814 may stop iteration after a pre-determined maximum number of iterations to avoid infinitely looping through the approximation process. In some embodiments, the iteration may also stop if the difference is less than the pre-determined threshold and the iteration count is greater than zero, as discussed previously in connection with operation 1204.

In some embodiments, the model ƒ(x) may be a credit model. In some embodiments, the apparatus 800 may include means such as processor 802, memory 804, communications hardware 806, or the like, for determining an explanation for a credit decision based on the SHAP value ϕᵢ and the model ƒ(x). For example, a credit score associated with a feature vector x′ may be declined, and the SHAP value may be computed to provide an explanation for why the credit score x′ is declined. The SHAP value ϕᵢ may be computed for each feature from the vector of features x′ to determine the most significant features that may provide an explanation for the credit score declining.

FIGS. 9, 10, 11, and 12 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable improved ways of computing SHAP value efficiently. Example embodiments thus provide tools that overcome the problems faced when determining model explanations using Shapley explanations. Moreover, embodiments described herein avoid inaccurate approximations when the model order is known or has a known functional decomposition, and compute exact values faster and more efficiently than existing methods.

As these examples all illustrate, example embodiments contemplated herein provide technical solutions that solve real-world problems faced during providing model explanations. And while model explanations have been an issue for decades, the recent rise in popularity of machine learning models, which are typically difficult to interpret, has made this problem significantly more acute. At the same time, applicant has developed new methods improvements to the functioning of computer devices using Shapley explanations that improve over existing methods and thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for computing a Shapley additive explanation (SHAP) value ϕᵢ using model structure information, the method comprising:
receiving, by communications hardware, a model ƒ(x) that uses a vector of features x as input, wherein the model has a known functional decomposition;
generating, by functional decomposition circuitry and using the known functional decomposition, a set of lower order terms ƒᵥ(xᵥ), wherein a lower order term from the set of lower order terms takes a subset of the features as input, wherein a sum of the set of lower order terms equals the model ƒ(x);
computing, by SHAP circuitry, a set of lower-order SHAP values ϕᵢ(ƒᵥ) for the set of lower order terms; and
computing, by the SHAP circuitry, the SHAP value ϕᵢ for the model based on a sum of the set of lower-order SHAP values.

2. The method of claim 1, wherein the lower order term from the set of lower order terms is expressed in a form Σ_{v⊆M} ƒᵥ(xᵥ), wherein M is a set of the features.

3. The method of claim 1, wherein the known functional decomposition of the model is a functional ANOVA (fANOVA) decomposition.

4. The method of claim 1, wherein computing the set of lower-order SHAP values uses a cost function c(ƒ,u), wherein for c(ƒ,u):
$$c ( {f}_{1} + {f}_{2} , u ) = c ( {f}_{1} , u ) + c ( {f}_{2} , u ) ;$$
and
in an instance in which ƒ(x)=ƒᵥ(xᵥ) and ƒ(x) only depends on xᵥ, c(ƒ,u)=c(ƒᵥ,u∩v).

5. The method of claim 4, wherein the cost function is a B-SHAP cost function.

6. The method of claim 5, wherein computing the set of lower-order SHAP values uses a B-SHAP Shapley definition.

7. The method of claim 4, wherein the cost function is a kernel SHAP cost function.

8. The method of claim 7, wherein computing the set of lower-order SHAP values uses a kernel SHAP Shapley definition.

9. The method of claim 1, wherein the model ƒ(x) is a credit model and the method further comprises:
determining an explanation for a credit decision based on the SHAP value ϕᵢ and the model ƒ(x).

10. An apparatus for computing a SHAP value ϕᵢ using model structure information, the apparatus comprising:
communications hardware configured to receive a model ƒ(x) that uses a vector of features x as input, wherein the model has a known functional decomposition;
functional decomposition circuitry configured to generate, using the known functional decomposition, a set of lower order terms ƒᵥ(xᵥ), wherein a lower order term from the set of lower order terms takes a subset of the features as input, wherein a sum of the set of lower order terms equals the model ƒ(x); and
SHAP circuitry configured to:
compute a set of lower-order SHAP values ϕᵢ(ƒᵥ) for the set of lower order term, and
compute the SHAP value ϕᵢ for the model based on a sum of the set of lower-order SHAP values.

11. The apparatus of claim 10, wherein the lower order term from the set of lower order terms is expressed in a form Σ_{v⊆M} ƒᵥ(xᵥ), wherein M is a set of the features.

12. The apparatus of claim 10, wherein the known functional decomposition of the model is a fANOVA decomposition.

13. The apparatus of claim 10, wherein the SHAP circuitry is configured to compute the set of lower-order SHAP values using a cost function c(ƒ,u), wherein for c(ƒ,u):
$$c ( {f}_{1} + {f}_{2} , u ) = c ( {f}_{1} , u ) + c ( {f}_{2} , u ) ;$$
in an instance in which ƒ(x)=ƒᵥ(xᵥ) and ƒ(x) only depends on xᵥ, c(ƒ,u)=c(ƒᵥ,u∩v).

14. The apparatus of claim 13, wherein the cost function is a B-SHAP cost function.

15. The apparatus of claim 14, wherein the SHAP circuitry is configured to compute the set of lower-order SHAP values using a B-SHAP Shapley definition.

16. The apparatus of claim 13, wherein the cost function is a kernel SHAP cost function.

17. The apparatus of claim 16, wherein the SHAP circuitry is configured to compute the set of lower-order SHAP values using a kernel SHAP Shapley definition.

18. The apparatus of claim 10, wherein the model ƒ(x) is a credit model, wherein the apparatus is further configured to determine an explanation for a credit decision based on the SHAP value ϕᵢ and the model ƒ(x).

19. A computer program product for computing a SHAP value ϕᵢ using model structure information, the computer program product comprising at least one non-transitory computer-readable storage medium storing software instructions that, when executed, cause an apparatus to:
receive a model ƒ(x) that uses a vector of features x as input, wherein the model has a known functional decomposition;
generate, using the known functional decomposition, a set of lower order terms ƒᵥ(xᵥ), wherein a lower order term from the set of lower order terms takes a subset of the features as input, wherein a sum of the set of lower order terms equals the model ƒ(x);
compute a set of lower-order SHAP values ϕᵢ(ƒᵥ) for the set of lower order terms; and
compute the SHAP value ϕᵢ for the model based on a sum of the set of lower-order SHAP values.

20. The computer program product of claim 19, wherein the known functional decomposition of the model is a fANOVA decomposition.

21. A method for computing a Shapley additive explanation (SHAP) value ϕᵢ at order K using model structure information, the method comprising:
receiving, by communications hardware, a model ƒ(x) that takes a vector of p features x as input;
deriving the SHAP value ϕᵢ at order K by:
determining, by SHAP circuitry, the order K for the SHAP value;
determining, by SHAP circuitry, a set u consisting of features of the model ƒ(x) without a feature i;
in an instance in which K=1, computing, by SHAP circuitry, the SHAP value ϕᵢ at order K based on a cost function depending on the model, the set u, and the feature i;
in an instance in which K=2, computing by SHAP circuitry, ϕᵢ at order K based on an average of gradients of the cost function with respect to the set u and a complement of u; and
in an instance in which K≥3:
solving, by solver circuitry, a system of q+1 equations for a set of coefficients aₘ wherein q is the floor of (K−1)/2, wherein the system of equations depends on p, and
computing, by the SHAP circuitry, the SHAP value ϕᵢ at order K based on the set of coefficients aₘ and an average gradient of the cost function for all subsets of the vector of p features.

22. The method of claim 21, wherein determining the order K comprises determining the order of the model ƒ(x), wherein the order K is the order of the model ƒ(x), wherein the SHAP value ϕᵢ at order K is an exact SHAP value for the model ƒ(x).

23. The method of claim 21, further comprising initializing an iteration count to 0, wherein determining the order K comprises:
in an instance in which the iteration count is 0, setting, by the SHAP circuitry, the order K to equal 1; and
in an instance in which the iteration count is greater than 0, setting, by the SHAP circuitry, the order K to equal to twice the value of the iteration count,
wherein deriving the SHAP value ϕᵢ at order K further includes:
in an instance in which the iteration count is greater than 0, computing, by approximation circuitry, a difference by subtracting the SHAP value at order K from a SHAP value of a previous order, normalized by a variance of the SHAP value at order K;
in an instance in which the difference is less than a pre-determined threshold and the iteration count is greater than 0, identifying, by the approximation circuitry, the SHAP value at order K as an approximate SHAP value ϕᵢ for the model ƒ(x);
increasing, by the approximation circuitry, the iteration count by 1;
identifying, by the approximation circuitry, the SHAP value at order K as the SHAP value of the previous order; and
iterating the derivation of the SHAP value ϕᵢ at order K until the order K is greater than a pre-determined maximum order.

24. The method of claim 21, wherein the set of lower-order SHAP values are computed using a cost function c(ƒ,u), wherein for c(ƒ,u):
$$c ( {f}_{1} + {f}_{2} , u ) = c ( {f}_{1} , u ) + c ( {f}_{2} , u ) ;$$
and
in an instance in which ƒ(x)=ƒᵥ(xᵥ) and ƒ(x) only depends on xᵥ, c(ƒ,u)=c(ƒᵥ,u∩v).

25. The method of claim 24, wherein the cost function is a B-SHAP cost function.

26. The method of claim 24, wherein the cost function is a kernel SHAP cost function.

27. The method of claim 21, wherein the model ƒ(x) is a credit model and the method further comprises:
determining an explanation for a credit decision based on the SHAP value ϕᵢ and the model ƒ(x).

28. An apparatus for computing a SHAP value ϕᵢ using model structure information, the apparatus comprising:
communications hardware configured to receive a model ƒ(x) that takes a vector of p features x as input; and
SHAP circuitry configured to derive the SHAP value ϕᵢ at order K by:
determining the order K for the SHAP value;
determining a set u consisting of features of the model ƒ(x) without a feature i;
in an instance in which K=1, computing, by SHAP circuitry, the SHAP value ϕᵢ at order K based on a cost function depending on the model, the set u, and the feature i;
in an instance in which K=2, computing ϕᵢ at order K based on an average of gradients of the cost function with respect to the set u and a complement of u; and
in an instance in which K≥3:
solving a system of q+1 equations for a set of coefficients aₘ wherein q is the floor of (K−1)/2, wherein the system of equations depends on p, and
computing the SHAP value ϕᵢ at order K based on the set of coefficients aₘ and an average gradient of the cost function for all subsets of the vector of p features.

29. The apparatus of claim 28, wherein determining the order K comprises determining the order of the model ƒ(x), wherein the order K is the order of the model ƒ(x), wherein the SHAP value ϕᵢ at order K is an exact SHAP value for the model ƒ(x).

30. The apparatus of claim 28, further comprising approximation circuitry configured to initialize an iteration count to 0, wherein the SHAP circuitry is further configured so that determining the order K comprises:
in an instance in which the iteration count is 0, setting the order K to equal 1; and
in an instance in which the iteration count is greater than 0, setting the order K to equal to twice the value of the iteration count,
wherein the approximation circuitry is further configured so that deriving the SHAP value ϕᵢ at order K further includes:
in an instance in which the iteration count is greater than 0, computing a difference by subtracting the SHAP value at order K from a SHAP value of a previous order, normalized by a variance of the SHAP value at order K;
in an instance in which the difference is less than a pre-determined threshold and the iteration count is greater than 0, identifying the SHAP value at order K as an approximate SHAP value ϕᵢ for the model ƒ(x);
increasing the iteration count by 1;
identifying the SHAP value at order K as the SHAP value of the previous order; and
iterating the derivation of the SHAP value ϕᵢ at order K until the order K is greater than a pre-determined maximum order.

31. The apparatus of claim 28, wherein the SHAP circuitry is configured to compute the set of lower-order SHAP values using a cost function c(ƒ,u), wherein for c(ƒ,u):
$$c ( {f}_{1} + {f}_{2} , u ) = c ( {f}_{1} , u ) + c ( {f}_{2} , u ) ;$$
and
in an instance in which ƒ(x)=ƒᵥ(xᵥ) and ƒ(x) only depends on xᵥ, c(ƒ,u)=c(ƒᵥ,u∩v).

32. The apparatus of claim 31, wherein the cost function is a B-SHAP cost function.

33. The apparatus of claim 31, wherein the cost function is a kernel SHAP cost function.

34. The apparatus of claim 28, wherein the model ƒ(x) is a credit model, wherein the SHAP circuitry is further configured to:
determine an explanation for a credit decision based on the SHAP value ϕᵢ and the model ƒ(x).

35. A computer program product for computing a SHAP value ϕᵢ using model structure information, the computer program product comprising at least one non-transitory computer-readable storage medium storing software instructions that, when executed, cause an apparatus to:
receive a model ƒ(x) that takes a vector of p features x as input;
derive the SHAP value ϕᵢ at order K by:
determining an order K for the SHAP value;
determining a set u consisting of features of the model ƒ(x) without a feature i;
in an instance in which K=1, computing a SHAP value ϕᵢ for the model at order K based on a cost function depending on the model, the set u, and the feature i;
in an instance in which K=2, computing ϕᵢ at order K based on an average of gradients of the cost function with respect to the set u and a complement of u; and
in an instance in which K≥3:
solving a system of q+1 equations for a set of coefficients aₘ wherein q is the floor of (K−1)/2, wherein the system of equations depends on p, and
computing the SHAP value ϕᵢ at order K based on the set of coefficients aₘ and an average gradient of the cost function for all subsets of the vector of p features.

36. The computer program product of claim 35, wherein determining the order K comprises determining the order of the model ƒ(x), wherein the order K is the order of the model ƒ(x), wherein the SHAP value ϕᵢ at order K is an exact SHAP value for the model ƒ(x).

37. The computer program product of claim 35, wherein the software instructions, when executed, further cause the apparatus to initialize an iteration count to 0, wherein determining the order K comprises:
in an instance in which the iteration count is 0, setting the order K to equal 1; and
in an instance in which the iteration count is greater than 0, setting the order K to equal to twice the value of the iteration count,
wherein deriving the SHAP value ϕᵢ at order K further includes:
in an instance in which the iteration count is greater than 0, computing a difference by subtracting the SHAP value at order K from a SHAP value of a previous order, normalized by a variance of the SHAP value at order K;
in an instance in which the difference is less than a pre-determined threshold and the iteration count is greater than 0, identifying the SHAP value at order K as an approximate SHAP value ϕᵢ for the model ƒ(x);
increasing the iteration count by 1;
identifying the SHAP value at order K as the SHAP value of the previous order; and
iterating the derivation of the SHAP value ϕᵢ at order K until the order K is greater than a pre-determined maximum order.

38. The computer program product of claim 35, wherein the set of lower-order SHAP values are computed using a cost function c(ƒ,u), wherein for c(ƒ,u):
$$c ( {f}_{1} + {f}_{2} , u ) = c ( {f}_{1} , u ) + c ( {f}_{2} , u ) ;$$
and
in an instance in which ƒ(x)=ƒᵥ(xᵥ) and ƒ(x) only depends on xᵥ, c(ƒᵥ,u)=c(ƒᵥ,u∩v).

39. The computer program product of claim 35, wherein the cost function is a B-SHAP cost function.

40. The computer program product of claim 35, wherein the cost function is a kernel SHAP cost function.
